(19) United States
(12) Patent Application Publication
(10) Pub. No.: US 2024/0146472 A1
(43) Pub. Date: May 2, 2024

(54) FREQUENCY HOPPING IN NOMA

(71) Applicant: Huawei Technologies Co., Ltd., Shenzhen (CN)

(72) Inventors: Sanjeewa Herath, Ottawa (CA); Monirosharieh Vameghestahbanati, Kanata (CA)

(21) Appl. No.: 18/529,963

(22) Filed: Dec. 5, 2023

Related U.S. Application Data
(63) Continuation of application No. PCT/CN2021/110694, filed on Aug. 5, 2021.

(51) Int. Cl. H04L 5/00; H04L 1/00

(52) U.S. Cl. CPC H04L 5/001; H04L 1/0068

(57) ABSTRACT

A system and method of using resource hopping together with non-orthogonal multiple access (NOMA) are provided. A second resource hopping pattern is derived from a first resource hopping pattern belonging to a resource hopping pattern pool. Each resource hopping pattern is a pattern of resource locations for use in wireless communications. The second resource hopping pattern is different from the first resource hopping pattern. The derived hopping pattern is used to communicate a NOMA signal. Advantageously, with this approach, flexibility is provided for hopping pattern utilization. Once a transmitter/receiver is aware of the resource hopping pattern pool, the transmitter/receiver can obtain the second hopping pattern without having to store a corresponding second hopping pattern pool. The second hopping pattern can be derived to suit particular transmission conditions without the need to store a separate hopping pattern pool for each transmission condition.

### CROSS-REFERENCE TO RELATED APPLICATIONS

This application is a continuation of International Application No. PCT/CN2021/099034 filed on Jun. 9, 2021, which application is hereby incorporated by reference in its entirety.

### TECHNICAL FIELD

The application relates to the use of frequency hopping for non-orthogonal multiple access communications, and more generally to wireless communications.

### BACKGROUND

With the development of Internet of Things (IoT) and massive machine type communication (mMTC), there is a growing demand for providing massive connectivity while keeping the device cost reasonably low. Hardware components such as a power amplifier with a large dynamic range are costly and therefore, in the regime of low-cost mMTC communication system, low peak average power ratio (PAPR) is vital. The non-orthogonal multiple access (NoMA) technology is capable of providing massive connectivity to a large number of devices/user equipments (UEs) communicating/transmitting simultaneously achieving high spectral efficiency. In NoMA, devices/UEs/transmitters are allowed to transmit in the same physical resource simultaneously. Such physical resources can be time, frequency, beam, antenna port etc. Such physical resources may, for example, be defined by resource blocks (RBs), resource elements (REs), slot, frame in OFDM resource grid. Such NoMA technology can apply transmission techniques such as spreading (linear and non-linear spreading), sparse mapping, and scrambling for separating overlapping transmissions at the receiver side; these techniques allow for the detection of the information bits in the presence of the interference caused by transmission collision. A non-exhaustive list of NoMA schemes using such transmission technique can be given as sparse code multiple access (SCMA), interleave division (IDMA), multi-user shared access (MUSA), interleave-grid multiple access (IGMA), low code rate spreading (LCRS), rate splitting multiple access (RSMA), low density spreading (LDS), pattern division multiple access (PDMA) etc.

While there are numerous transmission techniques that can provide a low PAPR property, only a few such techniques provide good performance when combined with NoMA technology. For example, a NoMA technology that works well with a cyclic prefix—orthogonal frequency division multiplexing (CP-OFDM) waveform cannot provide low PAPR as CP-OFDM inherently has high PAPR due to constructively adding symbols leading to high peaks in the transmitted OFDM signal. On the other hand, a waveform such as discrete Fourier transform-spread-OFDM (DFT-s-OFDM) can provide low-PAPR but can have poor link performance when NoMA technology is applied. For example, the DFT-s-OFDM waveform is known to have a noise enhancement effect and therefore, poor link performance compared to CP-OFDM. Several NoMA schemes relying on sparsity, in which different sparse patterns are used for UE/device transmission, can have varying performance due to interference levels from collisions and PAPR. In a scheme that uses sparsity based NoMA together with a waveform such as DFT-s-OFDM, the sparsity and DFT spreading can vary the interference levels from collisions and PAPR. As an example, application of DFT spreading (to obtain the DFT-s-OFDM waveform), together with application of spreading of the size of the number of total subcarriers (including sparse subcarriers) can remove the sparsity leading to poor multi-user separation at the receiver. Using the DFT spreading of the size of non-sparse symbol mapped locations can have an impact on the waveform operations (such as noise enhancement effect) leading to difference in link performance. As such, not all NoMA techniques with any given waveform such as CP-OFDM, DFT-s-OFDM can provide the low-PAPR property and good link performance (e.g. block error rate (BLER), transmission bit rate, throughput, capacity) simultaneously which are desired features of a good transmission technique for use cases such as mMTC.

### SUMMARY

According to one aspect of the present disclosure, there is provided a method in an apparatus or a network device. The method involves deriving a second resource hopping pattern from a first resource hopping pattern belonging to a resource hopping pattern pool. Each resource hopping pattern is a pattern of resource locations for use in wireless communications. The second resource hopping pattern is different from the first resource hopping pattern in terms of at least one of: number of resource locations included in the resource hopping pattern; resource locations included in the hopping pattern; communicating a non-orthogonal multiple access (NOMA) signal using the second resource hopping pattern. Note that communicating can include transmitting or receiving, or both transmitting and receiving.

Advantageously, with this approach, flexibility is provided for hopping pattern utilization. Once a transmitter/receiver is aware of the resource hopping pattern pool, the transmitter/receiver can obtain the second hopping pattern without having to store a corresponding second hopping pattern pool. The second hopping pattern can be derived to suit particular transmission conditions without the need to store a separate hopping pattern pool for each transmission condition. Moreover, optionally, a transmitter and receiver or both can dynamically or semi-statically be configured to use different hopping patterns. Furthermore, communication systems can be configured easily with multiple interpretation of hopping patterns.

In some embodiments, where each resource location of the first resource hopping pattern has M physical resource dimensions, with Aⱼ possibilities in for the i-th dimension, where i=1, . . . , M, M>=2, Aᵢ>=2, and each resource location of the second resource hopping pattern has M physical resource dimensions, with Bᵢ possibilities for the i-th dimension, where i=1, . . . , M, where all Bᵢ<=Aᵢ and at least one Bᵢ<Aᵢ.

This provides flexibility in how the second hopping pattern is derived.

In some embodiments, the M physical resource dimensions include time and at least one of frequency or space.

In some embodiments, deriving the second resource hopping pattern from the first resource hopping pattern belonging to the resource hopping pattern pool involves puncturing the first resource hopping pattern to produce the second resource hopping pattern. Puncturing involves omitting at least one resource location from the first hopping pattern.

Advantageously, this provides a very simple approach to deriving the second hopping pattern.

In some embodiments, the method further involves communicating signalling that at least partly indicates how to derive the second resource hopping pattern from the first resource hopping pattern.

Advantageously, this allows the manner of derivation to be updated, for example as conditions change, again, without the need to store multiple hopping pattern pools.

In some embodiments, the method further involves communicating signalling indicating an index of the first resource hopping pattern.

In some embodiments, the method further involves communicating signalling to configure the resource hopping pool.

Advantageously, this signalling may be used to update or modify the resource hopping pattern pool.

In some embodiments, the method further involves communicating signalling indicating a multiple access (MA) signature or a pattern of MA signatures, wherein communicating using the modified resource hopping pattern comprises using the indicated MA signature or pattern of MA signatures.

By using MA signatures together with resource hopping patterns, advantageously, it is possible to tolerate increased overlap/interference between hopping patterns, as the signals can still be separated based on MA signatures.

In some embodiments, each resource hopping pattern of the resource hopping pattern pool hops between frequency locations that belong to a set of non-adjacent frequency locations, and no frequency location of the set appears twice in any resource hopping pattern.

In some embodiments, the method described above, executed by a network device: the pool comprises at least one group of resource hopping patterns, wherein within each group of resource hopping patterns the resource hopping patterns are orthogonal to each other; the method further comprising assigning, by the network device, the same hopping pattern to multiple apparatus.

With this approach, there is no interference as between hopping patterns within the group since they are orthogonal, but there is interference between the multiple transmissions that use the same hoping pattern.

In some embodiments, the method as described above is executed by a network device, and the pool includes at least one group of resource hopping patterns. Within each group of resource hopping patterns the resource hopping patterns are orthogonal to each other. A respective different MA signature is associated with each group of resource hopping patterns. The method further involves assigning, by the network device, a resource hopping pattern, the resource hopping pattern being one of the resource hopping patterns of one of the at least one group, and assigning the respective MA signature of the one of the at least one group.

With this approach, there is no interference as between hopping patterns within the group since they are orthogonal, but there is interference between the multiple transmissions that use the same hopping pattern. MA signatures are used to separate the transmissions that use the same hopping pattern.

In some embodiments, the method further involves assigning, by the network device, an MA Signature hopping sequence that hops simultaneously with resource hopping.

According to another aspect of the present disclosure, there is provided an apparatus or a network device that includes a processor and memory, the apparatus or network device configured to execute any one or combination of the methods summarized above.

### BRIEF DESCRIPTION OF THE DRAWINGS

Reference will now be made, by way of example, to the accompanying drawings which show example embodiments of the present application, and in which:

FIG. 1 is a schematic diagram of an example communication system suitable for implementing examples described herein;

FIG. 2 is a schematic diagram of another example communication system suitable for implementing examples described herein;

FIG. 3 is a block diagram illustrating example devices that may implement the methods and teachings according to this disclosure;

FIG. 4 is a block diagram illustrating example computing modules that may implement the methods and teachings according to this disclosure;

FIG. 5 illustrates four carriers on a frequency spectrum of a wireless medium;

FIG. 6 illustrates a single carrier having a single bandwidth part (BWP) consisting of two non-contiguous spectrum resources;

FIG. 7 illustrates a BWP on a frequency spectrum of a wireless medium;

FIG. 8 illustrates a single BWP having four non-contiguous spectrum resources;

FIG. 9 shows an example of NoMA transmission with hopping;

FIG. 10 is a flowchart of NoMA transmission provided by an embodiment of the application;

FIG. 11 is an example of adjustable hopping pools;

FIG. 12 is an example of pattern pools from different punctured locations;

FIG. 13 is an example of transmission hopping;

FIG. 14 is an example of overloaded orthogonal transmission;

FIG. 15 is an example of hopping with MA signature assigned;

FIG. 16 is an example of MA signature assignment together with frequency hopping;

FIG. 17 is an example of MA signature hopping together with frequency hopping;

FIG. 18 is a flowchart of a method of uplink NoMA transmission, including signaling; and

FIG. 19 is a flowchart of a method of downlink NoMA transmission, including signaling.

### DETAILED DESCRIPTION OF ILLUSTRATED EMBODIMENTS

### Example Communication Systems and Devices

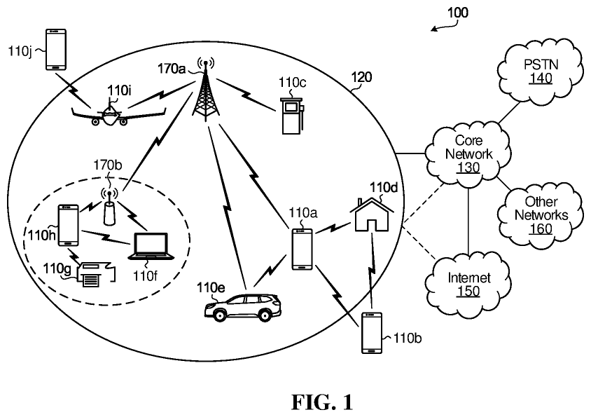

Referring to FIG. 1, as an illustrative example without limitation, a simplified schematic illustration of a communication system is provided. The communication system 100 comprises a radio access network 120. The radio access network 120 may be a next generation (e.g. sixth generation (6G) or later) radio access network, or a legacy (e.g. 5G or 4G) radio access network. One or more communication electric device (ED) 110a-120j (generically referred to as 110) may be interconnected to one another or connected to one or more network nodes (170a, 170b, generically referred to as 170) in the radio access network 120. A core network 130 may be a part of the communication system and may be dependent or independent of the radio access technology used in the communication system 100. Also, the communication system 100 comprises a public switched telephone network (PSTN) 140, the internet 150, and other networks 160.

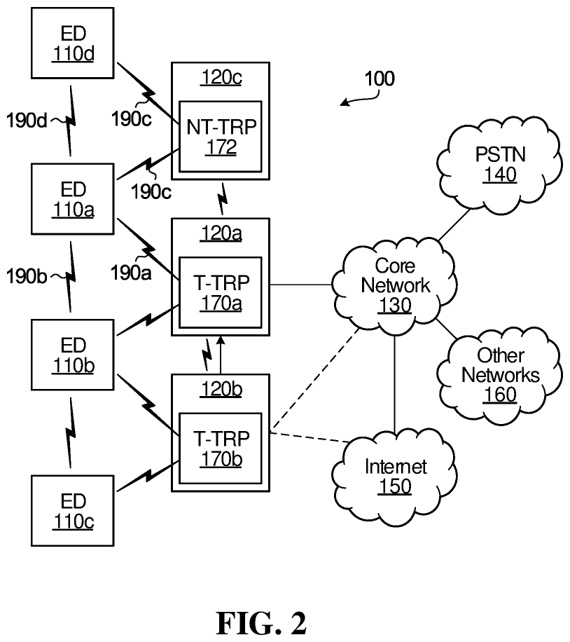

FIG. 2 illustrates an example communication system 100. In general, the communication system 100 enables multiple wireless or wired elements to communicate data and other content. The purpose of the communication system 100 may be to provide content, such as voice, data, video, and/or text, via broadcast, multicast and unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, etc.). The communication system 100 may provide a high degree of availability and robustness through a joint operation of the terrestrial communication system and the non-terrestrial communication system. For example, integrating a non-terrestrial communication system (or components thereof) into a terrestrial communication system can result in what may be considered a heterogeneous network comprising multiple layers. Compared to conventional communication networks, the heterogeneous network may achieve better overall performance through efficient multi-link joint operation, more flexible functionality sharing, and faster physical layer link switching between terrestrial networks and non-terrestrial networks.

The terrestrial communication system and the non-terrestrial communication system could be considered sub-systems of the communication system. In the example shown, the communication system 100 includes electronic devices (ED) 110a-110d (generically referred to as ED 110), radio access networks (RANs) 120a-120b, non-terrestrial communication network 120c, a core network 130, a public switched telephone network (PSTN) 140, the Internet 150, and other networks 160. The RANs 120a-120b include respective base stations (BSs) 170a-170b, which may be generically referred to as terrestrial transmit and receive points (T-TRPs) 170a-170b. The non-terrestrial communication network 120c includes an access node 120c, which may be generically referred to as a non-terrestrial transmit and receive point (NT-TRP) 172.

Any ED 110 may be alternatively or additionally configured to interface, access, or communicate with any other T-TRP 170a-170b and NT-TRP 172, the Internet 150, the core network 130, the PSTN 140, the other networks 160, or any combination of the preceding. In some examples, ED 110a may communicate an uplink and/or downlink transmission over an interface 190a with T-TRP 170a. In some examples, the EDs 110a, 110b and 110d may also communicate directly with one another via one or more sidelink air interfaces 190b. In some examples, ED 110d may communicate an uplink and/or downlink transmission over an interface 190c with NT-TRP 172.

The air interfaces 190a and 190b may use similar communication technology, such as any suitable radio access technology. For example, the communication system 100 may implement one or more channel access methods, such as code division multiple access (CDMA), time division multiple access (TDMA), frequency division multiple access (FDMA), orthogonal FDMA (OFDMA), or single-carrier FDMA (SC-FDMA) in the air interfaces 190a and 190b. The air interfaces 190a and 190b may utilize other higher dimension signal spaces, which may involve a combination of orthogonal and/or non-orthogonal dimensions.

The air interface 190c can enable communication between the ED 110d and one or multiple NT-TRPs 172 via a wireless link or simply a link. In some examples, the link is a dedicated connection for unicast transmission, a connection for broadcast transmission, or a connection between a group of EDs and one or multiple NT-TRPs for multicast transmission.

The RANs 120a and 120b are in communication with the core network 130 to provide the EDs 110a 110b, and 110c with various services such as voice, data, and other services. The RANs 120a and 120b and/or the core network 130 may be in direct or indirect communication with one or more other RANs (not shown), which may or may not be directly served by core network 130, and may or may not employ the same radio access technology as RAN 120a, RAN 120b or both. The core network 130 may also serve as a gateway access between (i) the RANs 120a and 120b or EDs 110a 110b, and 110c or both, and (ii) other networks (such as the PSTN 140, the internet 150, and the other networks 160). In addition, some or all of the EDs 110a 110b, and 110c may include functionality for communicating with different wireless networks over different wireless links using different wireless technologies and/or protocols. Instead of wireless communication (or in addition thereto), the EDs 110a 110b, and 110c may communicate via wired communication channels to a service provider or switch (not shown), and to the internet 150. PSTN 140 may include circuit switched telephone networks for providing plain old telephone service (POTS). Internet 150 may include a network of computers and subnets (intranets) or both, and incorporate protocols, such as Internet Protocol (IP), Transmission Control Protocol (TCP), User Datagram Protocol (UDP). EDs 110a 110b, and 110c may be multimode devices capable of operation according to multiple radio access technologies, and incorporate multiple transceivers necessary to support such.

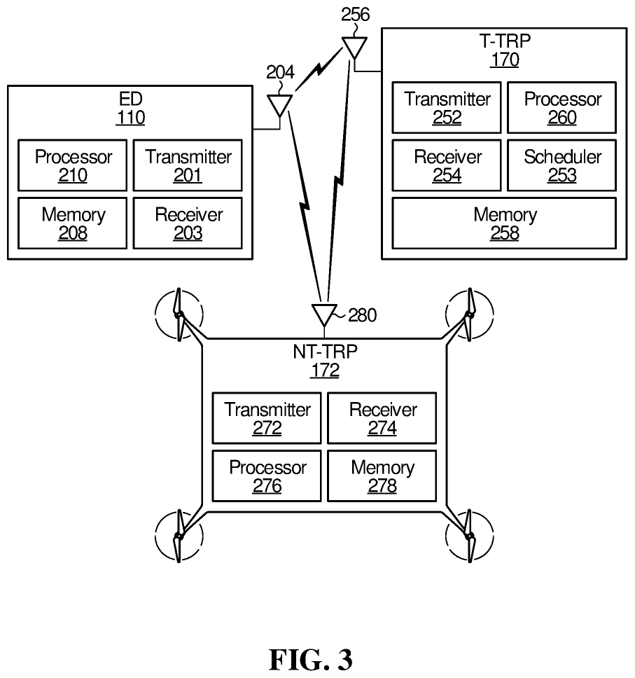

FIG. 3 illustrates another example of an ED 110 and a base station 170a, 170b and/or 170c. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), internet of things (IOT), virtual reality (VR), augmented reality (AR), industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, an industrial device, or apparatus (e.g. communication module, modem, or chip) in the forgoing devices, among other possibilities. Future generation EDs 110 may be referred to using other terms. The base station 170a and 170b is a T-TRP and will hereafter be referred to as T-TRP 170. Also shown in FIG. 3, a NT-TRP will hereafter be referred to as NT-TRP 172. Each ED 110 connected to T-TRP 170 and/or NT-TRP 172 can be dynamically or semi-statically turned-on (i.e., established, activated, or enabled), turned-off (i.e., released, deactivated, or disabled) and/or configured in response to one of more of: connection availability and connection necessity.

The ED 110 includes a transmitter 201 and a receiver 203 coupled to one or more antennas 204. Only one antenna 204 is illustrated. One, some, or all of the antennas may alternatively be panels. The transmitter 201 and the receiver 203 may be integrated, e.g. as a transceiver. The transceiver is configured to modulate data or other content for transmission by at least one antenna 204 or network interface controller (NIC). The transceiver is also configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by the processing unit(s) 210. Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache, and the like.

The ED 110 may further include one or more input/output devices (not shown) or interfaces (such as a wired interface to the internet 150 in FIG. 1). The input/output devices permit interaction with a user or other devices in the network. Each input/output device includes any suitable structure for providing information to or receiving information from a user, such as a speaker, microphone, keypad, keyboard, display, or touch screen, including network interface communications.

The ED 110 further includes a processor 210 for performing operations including those related to preparing a transmission for uplink transmission to the NT-TRP 172 and/or T-TRP 170, those related to processing downlink transmissions received from the NT-TRP 172 and/or T-TRP 170, and those related to processing sidelink transmission to and from another ED 110. Processing operations related to preparing a transmission for uplink transmission may include operations such as encoding, modulating, transmit beamforming, and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g. by detecting and/or decoding the signaling). An example of signaling may be a reference signal transmitted by NT-TRP 172 and/or T-TRP 170. In some embodiments, the processor 276 implements the transmit beamforming and/or receive beamforming based on the indication of beam direction, e.g. beam angle information (BAI), received from T-TRP 170. In some embodiments, the processor 210 may perform operations relating to network access (e.g. initial access) and/or downlink synchronization, such as operations relating to detecting a synchronization sequence, decoding and obtaining the system information, etc. In some embodiments, the processor 210 may perform channel estimation, e.g. using a reference signal received from the NT-TRP 172 and/or T-TRP 170.

Although not illustrated, the processor 210 may form part of the transmitter 201 and/or receiver 203. Although not illustrated, the memory 208 may form part of the processor 210.

The processor 210, and the processing components of the transmitter 201 and receiver 203 may each be implemented by the same or different one or more processors that are configured to execute instructions stored in a memory (e.g. in memory 208). Alternatively, some or all of the processor 210, and the processing components of the transmitter 201 and receiver 203 may be implemented using dedicated circuitry, such as a programmed field-programmable gate array (FPGA), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP)), a site controller, an access point (AP), or a wireless router, a relay station, a remote radio head, a terrestrial node, a terrestrial network device, or a terrestrial base station, base band unit (BBU), remote radio unit (RRU), active antenna unit (AAU), remote radio head (RRH), central unit (CU), distribute unit (DU), positioning node, among other possibilities. The T-TRP 170 may be macro BSs, pico BSs, relay node, donor node, or the like, or combinations thereof. The T-TRP 170 may refer to the forging devices or apparatus (e.g. communication module, modem, or chip) in the forgoing devices.

In some embodiments, the parts of the T-TRP 170 may be distributed. For example, some of the modules of the T-TRP 170 may be located remote from the equipment housing the antennas of the T-TRP 170, and may be coupled to the equipment housing the antennas over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment housing the antennas of the T-TRP 170. The modules may also be coupled to other T-TRPs. In some embodiments, the T-TRP 170 may actually be a plurality of T-TRPs that are operating together to serve the ED 110, e.g. through coordinated multipoint transmissions.

The T-TRP 170 includes at least one transmitter 252 and at least one receiver 254 coupled to one or more antennas 256. Only one antenna 256 is illustrated. One, some, or all of the antennas may alternatively be panels. The transmitter 252 and the receiver 254 may be integrated as a transceiver. The T-TRP 170 further includes a processor 260 for performing operations including those related to: preparing a transmission for downlink transmission to the ED 110, processing an uplink transmission received from the ED 110, preparing a transmission for backhaul transmission to NT-TRP 172, and processing a transmission received over backhaul from the NT-TRP 172. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. The processor 260 may also perform operations relating to network access (e.g. initial access) and/or downlink synchronization, such as generating the content of synchronization signal blocks (SSBs), generating the system information, etc. In some embodiments, the processor 260 also generates the indication of beam direction, e.g. BAI, which may be scheduled for transmission by scheduler 253. The processor 260 performs other network-side processing operations described herein, such as determining the location of the ED 110, determining where to deploy NT-TRP 172, etc. In some embodiments, the processor 260 may generate signaling, e.g. to configure one or more parameters of the ED 110 and/or one or more parameters of the NT-TRP 172. Any signaling generated by the processor 260 is sent by the transmitter 252. Note that “signaling”, as used herein, may alternatively be called control signaling. Dynamic signaling may be transmitted in a control channel, e.g. a physical downlink control channel (PDCCH), and static or semi-static higher layer signaling may be included in a packet transmitted in a data channel, e.g. in a physical downlink shared channel (PDSCH).

A scheduler 253 may be coupled to the processor 260. The scheduler 253 may be included within or operated separately from the T-TRP 170, which may schedule uplink, downlink, and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or receiver 254. Also, although not illustrated, the processor 260 may implement the scheduler 253. Although not illustrated, the memory 258 may form part of the processor 260.

The processor 260, the scheduler 253, and the processing components of the transmitter 252 and receiver 254 may each be implemented by the same or different one or more processors that are configured to execute instructions stored in a memory, e.g. in memory 258. Alternatively, some or all of the processor 260, the scheduler 253, and the processing components of the transmitter 252 and receiver 254 may be implemented using dedicated circuitry, such as a FPGA, a GPU, or an ASIC.

Although the NT-TRP 172 is illustrated as a drone only as an example, the NT-TRP 172 may be implemented in any suitable non-terrestrial form. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110, processing an uplink transmission received from the ED 110, preparing a transmission for backhaul transmission to T-TRP 170, and processing a transmission received over backhaul from the T-TRP 170. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. In some embodiments, the processor 276 implements the transmit beamforming and/or receive beamforming based on beam direction information (e.g. BAI) received from T-TRP 170. In some embodiments, the processor 276 may generate signaling, e.g. to configure one or more parameters of the ED 110. In some embodiments, the NT-TRP 172 implements physical layer processing, but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or receiver 274. Although not illustrated, the memory 278 may form part of the processor 276.

The processor 276 and the processing components of the transmitter 272 and receiver 274 may each be implemented by the same or different one or more processors that are configured to execute instructions stored in a memory, e.g. in memory 278. Alternatively, some or all of the processor 276 and the processing components of the transmitter 272 and receiver 274 may be implemented using dedicated circuitry, such as a programmed FPGA, a GPU, or an ASIC. In some embodiments, the NT-TRP 172 may actually be a plurality of NT-TRPs that are operating together to serve the ED 110, e.g. through coordinated multipoint transmissions.

The T-TRP 170, the NT-TRP 172, and/or the ED 110 may include other components, but these have been omitted for the sake of clarity.

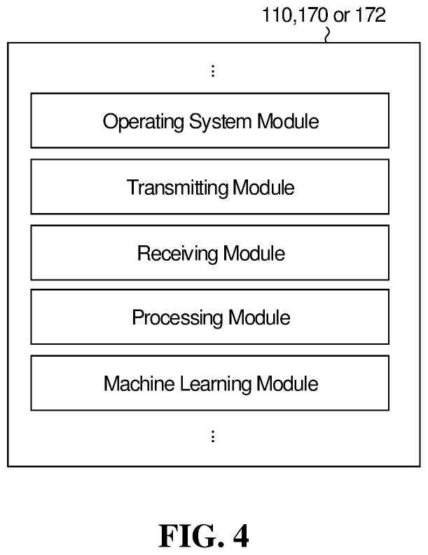

One or more steps of the embodiment methods provided herein may be performed by corresponding units or modules, according to FIG. 4. FIG. 4 illustrates units or modules in a device, such as in ED 110, in T-TRP 170, or in NT-TRP 172. For example, a signal may be transmitted by a transmitting unit or a transmitting module. For example, a signal may be transmitted by a transmitting unit or a transmitting module. A signal may be received by a receiving unit or a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU, or an ASIC. It will be appreciated that where the modules are implemented using software for execution by a processor for example, they may be retrieved by a processor, in whole or part as needed, individually or together for processing, in single or multiple instances, and that the modules themselves may include instructions for further deployment and instantiation.

Additional details regarding the EDs 110, T-TRP 170, and NT-TRP 172 are known to those of skill in the art. As such, these details are omitted here.

### Cells, Carriers, Bandwidth Parts (BWPs) and Occupied Bandwidth

A device, such as a base station, may provide coverage over a cell. Wireless communication with the device may occur over one or more carrier frequencies. A carrier frequency will be referred to as a carrier. A carrier may alternatively be called a component carrier (CC). A carrier may be characterized by its bandwidth and a reference frequency, e.g. the center or lowest or highest frequency of the carrier. A carrier may be on licensed or unlicensed spectrum. Wireless communication with the device may also or instead occur over one or more BWPs. For example, a carrier may have one or more BWPs. More generally, wireless communication with the device may occur over a wireless spectrum. The spectrum may comprise one or more carriers and/or one or more BWPs. The spectrum may be referred to as frequency resources. Different carriers and/or BWPs may be on distinct frequency resources.

A cell may include one or multiple downlink resources and optionally one or multiple uplink resources, or a cell may include one or multiple uplink resources and optionally one or multiple downlink resources, or a cell may include both one or multiple downlink resources and one or multiple uplink resources. As an example, a cell might only include one downlink carrier/BWP, or only include one uplink carrier/BWP, or include multiple downlink carriers/BWPs, or include multiple uplink carriers/BWPs, or include one downlink carrier/BWP and one uplink carrier/BWP, or include one downlink carrier/BWP and multiple uplink carriers/BWPs, or include multiple downlink carriers/BWPs and one uplink carrier/BWP, or include multiple downlink carriers/BWPs and multiple uplink carriers/BWPs. In some embodiments, a cell may instead or additionally include one or multiple sidelink resources, e.g. sidelink transmitting and receiving resources.

A BWP may be broadly defined as a set of contiguous or non-contiguous frequency subcarriers on a carrier, or a set of contiguous or non-contiguous frequency subcarriers on multiple carriers, or a set of non-contiguous or contiguous frequency subcarriers, which may have one or more carriers.

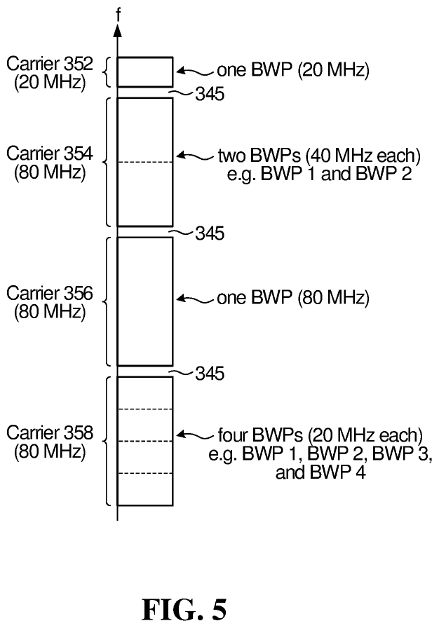

Therefore, in some embodiments, a carrier may have one or more BWPs. As an example, FIG. 5 illustrates four carriers on a frequency spectrum of a wireless medium. The four carriers are respectively labelled carriers 352, 354, 356, and 358. The four carriers are contiguous with each other, except that a guard band 345 may be interposed between adjacent pairs of contiguous carriers. Carrier 352 has a bandwidth of 20 MHz and consists of one BWP. Carrier 354 has a bandwidth of 80 MHz and consists of two adjacent contiguous BWPs, each BWP being 40 MHz, and respectively identified as BWP 1 and BWP 2. Carrier 356 has a bandwidth of 80 MHz and consists of one BWP. Carrier 358 has a bandwidth of 80 MHz and consists of four adjacent contiguous BWPs, each BWP being 20 MHz, and respectively identified as BWP 1, BWP 2, BWP 3, and BWP 4. Although not shown, a guard band may be interposed between adjacent BWPs.

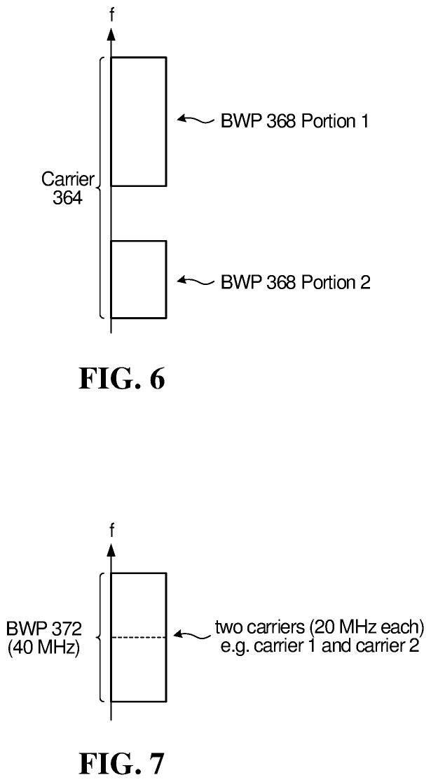

In some embodiments, a BWP has non-contiguous spectrum resources on one carrier. For example, FIG. 6 illustrates a single carrier 364 having a single BWP 368 consisting of two non-contiguous spectrum resources: BWP portion 1 and BWP portion 2.

In other embodiments, rather than a carrier having one or more BWPs, a BWP may have one or more carriers. For example, FIG. 7 illustrates a BWP 372 on a frequency spectrum of a wireless medium. BWP 372 has a bandwidth of 40 MHz and consists of two adjacent carriers, labelled carrier 1 and carrier 2, with each carrier having a bandwidth of 20 MHz. Carriers 1 and 2 are contiguous, except that a guard band (not shown) may be interposed between the carriers.

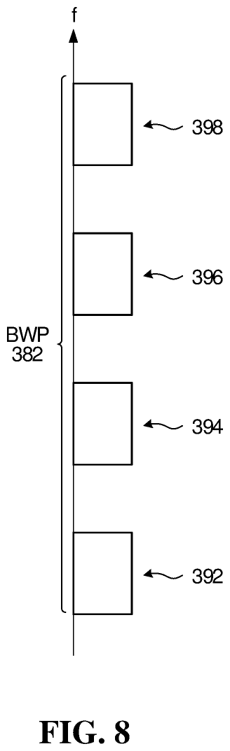

In some embodiments, a BWP may comprise non-contiguous spectrum resources which consists of non-contiguous multiple carriers. For example, FIG. 8 illustrates a single BWP 382 having four non-contiguous spectrum resources 392, 394, 396, and 398. Each non-contiguous spectrum resource consists of a single carrier. The first spectrum resource 392 is in a low band (e.g. the 2 GHz band) and consists of a first carrier (carrier 1). The second spectrum resource 394 is in a mmW band and consists of a second carrier (carrier 2). The third spectrum resource 396 (if it exists) is in the THz band and consists of a third carrier (carrier 3). The fourth spectrum resource 398 (if it exists) is in visible light band and consists of a fourth carrier (carrier 4). Resources in one carrier which belong to the BWP may be contiguous or non-contiguous. For example, the frequency resources of carrier 1 might be contiguous or non-contiguous.

Therefore, in view of the examples described in relation to FIGS. 5 to 8, it will be appreciated that a carrier may be a contiguous spectrum block for transmission and/or reception by device, such as a base station or a UE (e.g. like in FIG. 5), or a non-contiguous spectrum block for transmission and/or reception by a device (e.g. like in FIG. 6). A BWP may be a contiguous spectrum block for transmission and/or reception (e.g. like in FIGS. 5 and 7), or a contiguous spectrum block within a carrier (e.g. like in FIG. 5), or a non-contiguous spectrum block (e.g. like in FIGS. 6 and 8). A carrier may have one or more BWPs, or a BWP may have one or more carriers. A carrier or BWP may alternatively be referred to as spectrum.

As used herein, “carrier/BWP” refers to a carrier, or a BWP or both. For example, the sentence “the UE 110 sends a transmission on an uplink carrier/BWP” means that the UE 110 may send the transmission on an uplink carrier (that might or might not have one or more BWPs), or the UE may send the transmission on an uplink BWP (that might or might not have one or more carriers). The transmission might only be on a carrier, or might only be on a BWP, or might be on both a carrier and a BWP (e.g. on a BWP within a carrier).

Wireless communication may occur over an occupied bandwidth. The occupied bandwidth may be defined as the width of a frequency band such that, below the lower and above the upper frequency limits, the mean powers emitted are each equal to a specified percentage β/2 of the total mean transmitted power, for example, the value of β/2 is taken as 0.5%.

In some embodiments, a carrier, a BWP and/or an occupied bandwidth may be signaled by a network device (e.g. a base station) dynamically (e.g. in physical layer control signaling such as downlink control information (DCI)), semi-statically (e.g. in radio resource control (RRC) signaling or in the medium access control (MAC) layer), or be predefined based on the application scenario. Alternatively or additionally, a carrier, a BWP and/or an occupied bandwidth may be determined by a UE as a function of other parameters that are known by the UE, or may be fixed, e.g. by a standard.

In some embodiments herein, a carrier/BWP is sometimes configured as an “uplink carrier/BWP” or a “downlink carrier/BWP”. An uplink carrier/BWP is a carrier or BWP that is configured for uplink transmission. A downlink carrier/BWP is a carrier or BWP that is configured for downlink transmission.

Control information is discussed herein in some embodiments. Control information may sometimes instead be referred to as control signaling, signaling, configuration information, or a configuration. An example of control information is information configuring different carriers/BWPs. In some cases, control information may be dynamically indicated to the UE, e.g. in the physical layer in a control channel. An example of control information that is dynamically indicated is information sent in physical layer control signaling, e.g. downlink control information (DCI). Control information may sometimes be semi-statically indicated, e.g. in RRC signaling or in a MAC control element (MAC CE). A dynamic indication may be an indication in a lower layer (e.g. physical layer or layer 1 signaling such as DCI), rather than in a higher-layer (e.g. rather than in RRC signaling or in a MAC CE). A semi-static indication may be an indication in semi-static signaling. Semi-static signaling, as used herein, may refer to signaling that is not dynamic, e.g. higher-layer signaling, RRC signaling, and/or a MAC CE. Dynamic signaling, as used herein, may refer to signaling that is dynamic, e.g. physical layer control signaling sent in the physical layer, such as DCI.

It should be noted that while some embodiments of the present disclosure are described in relation to communications between a UE and a BS (for example, uplink and/or downlink transmissions), the present disclosure is in no way limited to these communications. The embodiments described herein may also or instead be implemented in sidelink, backhaul links and/or vehicle-to-everything (V2X) links, for example. Further, the embodiments described herein may apply to transmissions over licensed spectrum, unlicensed spectrum, terrestrial transmissions, non-terrestrial transmissions (for example, transmissions within non-terrestrial networks), and/or integrated terrestrial and non-terrestrial transmissions.

### Integrated Terrestrial Networks and Non-Terrestrial Networks

A terrestrial communication system may also be referred to as a land-based or ground-based communication system, although a terrestrial communication system can also, or instead, be implemented on or in water. The non-terrestrial communication system may bridge the coverage gaps for underserved areas by extending the coverage of cellular networks through non-terrestrial nodes, which will be key to ensuring global seamless coverage and providing mobile broadband services to unserved/underserved regions, in this case, it is hardly possible to implement terrestrial access-points/base-stations infrastructure in the areas like oceans, mountains, forests, or other remote areas.

The terrestrial communication system may be a wireless communication system using 5G technology and/or later generation wireless technology (e.g., 6G or later). In some examples, the terrestrial communication system may also accommodate some legacy wireless technology (e.g., 3G or 4G wireless technology). The non-terrestrial communication system may be a communications using the satellite constellations like conventional Geo-Stationary Orbit (GEO) satellites which utilizing broadcast public/popular contents to a local server, Low earth orbit (LEO) satellites establishing a better balance between large coverage area and propagation path-loss/delay, stabilize satellites in very low earth orbits (VLEO) enabling technologies substantially reducing the costs for launching satellites to lower orbits, high altitude platforms (HAPs) providing a low path-loss air interface for the users with limited power budget, or Unmanned Aerial Vehicles (UAVs) (or unmanned aerial system (UAS)) achieving a dense deployment since their coverage can be limited to a local area, such as airborne, balloon, quadcopter, drones, etc. In some examples, GEO satellites, LEO satellites, UAVs, HAPs and VLEOs may be horizontal and two-dimensional. In some examples, UAVs, HAPs and VLEOs coupled to integrate satellite communications to cellular networks emerging 3D vertical networks consist of many moving (other than geostationary satellites) and high altitude access points such as UAVs, HAPs and VLEOs.

### Artificial Intelligence (AI) and Sensing

In some embodiments, devices such as the ED 110, the T-TRP 170 and/or the NT-TRP 172 of FIG. 3 implement sensing technologies and/or AI technologies. Sensing and/or AI may be introduced into a telecommunication system to improve performance and efficiency.

AI and/or machine learning (ML) technologies may be applied in the physical layer and/or in the MAC layer. For the physical layer, AI/ML may improve component design and/or algorithm performance, including but not limited to channel coding, channel modelling, channel estimation, channel decoding, modulation, demodulation, MIMO, waveform, multiple access, PHY element parameter optimization and update, beam forming & tracking, and sensing & positioning. For the MAC layer, AI/ML capabilities such as learning, prediction and decision making, for example, may be utilized to solve complicated problems. According to an example, AI/ML may be utilized to improve functionality in the MAC layer through intelligent TRP management, intelligent beam management, intelligent channel resource allocation, intelligent power control, intelligent spectrum utilization, intelligent MCS, intelligent HARQ strategy, and/or intelligent Tx/Rx mode adaption.

In some embodiments, AI/ML architectures involve multiple nodes. The multiple nodes may be organized into two modes, i.e., centralized and distributed, both of which can be deployed in an access network, a core network, or an edge computing system or third network. The implementation of a centralized training and computing architecture may be restricted by a large communication overhead and strict user data privacy. A distributed training and computing architecture, such as distributed machine learning and federated learning, for example, may include several frameworks. AI/ML architectures could include an intelligent controller which may perform as single agent or multi-agent, based on joint optimization or individual optimization. A protocol and signaling mechanism may provide a corresponding interface link that can be personalized with customized parameters to meet particular requirements while minimizing signaling overhead and maximizing the whole system spectrum efficiency through personalized AI technologies.

Through the use of sensing technologies, terrestrial and non-terrestrial networks can enable a new range of services and applications such as earth monitoring, remote sensing, passive sensing and positioning, navigation, tracking, autonomous delivery and mobility. Terrestrial network-based sensing and non-terrestrial network-based sensing could provide intelligent, context-aware networks to enhance the UE experience. For an example, terrestrial network-based sensing and non-terrestrial network-based sensing could provide opportunities for localization and sensing applications based on a new set of features and service capabilities. Applications such as THz imaging and spectroscopy have the potential to provide continuous, real-time physiological information via dynamic, non-invasive, contactless measurements for future digital health technologies. Simultaneous localization and mapping (SLAM) methods might not only enable advanced cross reality (XR) applications, but also enhance the navigation of autonomous objects such as vehicles and drones. Further, measured channel data and sensing and positioning data can be obtained through large bandwidth, new spectrum, dense networks and more line-of-sight (LOS) links. Based on measured channel data and sensing and positioning data, a radio environmental map may be drawn through AI/ML methods, where channel information is linked to its corresponding positioning or environmental information to provide an enhanced physical layer design based on this map.

Sensing coordinators are nodes in a network that can assist in the sensing operation. These nodes can be stand-alone nodes dedicated to sensing operations or other nodes (for example the T-TRP 170, ED 110, or core network node) that perform sensing operations in parallel with communication transmissions. Protocol and signaling mechanisms may provide a corresponding interface link with customized parameters to meet particular requirements while minimizing signaling overhead and maximizing spectrum efficiency.

AI/ML and sensing methods may be data-hungry. Therefore, in order to involve AI/ML and sensing in wireless communications, a large amount of data may be collected, stored, and exchanged. The characteristics of wireless data may expand in multiple dimensions, such as from sub-6 GHz, millimeter to Terahertz carrier frequencies, from outdoor to indoor environments, and from text, voice to video. The data collecting, processing and usage may be performed in a unified framework or another framework.

### Beams and Beamforming

Some embodiments of the present disclosure relate to beams and beamforming in a wireless communication system. A beam may be formed through amplitude and/or phase weighting on data transmitted or received by at least one antenna. Alternatively or additionally, a beam may be formed by using another method, for example, adjusting a related parameter of an antenna unit. A beam may include a transmit (Tx) beam and/or a receive (Rx) beam. A Tx beam indicates a distribution of signal strength formed in different directions in space after a signal is transmitted through an antenna. An Rx beam indicates a distribution of signal strength of a wireless signal received by an antenna that is in different directions in space. From the perspective of a UE, a Tx beam may be an UL beam and a Rx beam may be a DL beam. Beam information for a beam may include a beam identifier, an antenna port identifier, a channel state information reference signal (CSI-RS) resource identifier, a synchronization signal block (SSB) resource identifier, a sounding reference signal (SRS) resource identifier and/or another reference signal resource identifier. Beam information for a beam may also or instead include precoding information for the beam, which may provide antenna phase and/or gain weightings to transmit and/or receive on the beam.

A UE and/or a BS may support multiple antenna panels (which are also referred to as “panels”) for transmitting and/or receiving data using multiple different beams. Each panel may operate as (or provide the functionality of) a unit of antenna group, an antenna array or an antenna sub-array. A particular panel at a UE or a BS can support a transmit and/or receive (Tx/Rx) beam independently of the other panels in the device. As such, multiple panels at a UE or BS may support multiple beams simultaneously, which may increase the rate of data transmission for the UE or the BS.

A unified approach for hopping by a transmitter in a NoMA transmission is provided that achieves good link performance such as BLER, PAPR. Methods include the following:
Methods of obtaining a shorter hopping pattern from a given longer hopping pattern;
Methods of selecting a subset of frequency hopping patterns from all possible hopping patterns to reduce signaling overhead and system complexity;
Methods of supporting NoMA and assigning MA signatures with frequency hopping.

In accordance with an embodiment of the application, shorter length hopping patterns are obtained by puncturing/truncating/pruning an existing relatively longer hopping pattern. In other words, hopping patterns of a size that is smaller in terms of K (number of blocks) or N (number of hop locations) or both are obtained by pruning hopping patterns of a size is larger than or equal in terms of K and N. A hopping pattern pool of hopping patterns with a smaller number of hop locations (frequency or time hop locations) is obtained by eliminating/dropping/removing corresponding hop locations from patterns of a hopping pattern pool having a larger number of hop locations.

In some embodiments, the hopping patterns are such that within a single transmission, a UE hops from a first resource associated with a first frequency location to a second resource associated with a second frequency location such that the UE hops to any given frequency location only once, i.e., a UE does not re-visit a frequency hop location, and the hopping resources do not overlap in frequency (or alternatively a non-zero gap in frequency hop locations can be imposed), and for a given hopping pattern, at least resource/frequency hop location included in the hopping pattern is common to multiple hopping patterns, such that NoMA transmission occurs when the hopping patterns are used simultaneously, for example by respective UEs.

In some embodiments, the hopping patterns are used together with multiple access (MA) signatures, and for at least for one hopping pattern, the MA signature hops simultaneously with frequency hopping. The MA signature can remain unchanged within the block of the symbols of a given resource block/hop location. In an alternative approach, an MA signature is mapped to more than one hopping pattern which are orthogonal to each other.

Consider a transmission scheme where the transmitter hops from one resource to another resource. An example of a resource is the time-frequency transmission opportunity in OFDMA. For example, in a typical OFDM transmission, one or more subcarriers in the frequency domain and one or more symbols in the time domain can represent a resource. In another example, one or more subcarriers in the frequency domain and one or more symbols in the time domain of a given transmit/receive beam can represent a resource. The transmitter may map constellation symbols to be transmitted into more than one resource.

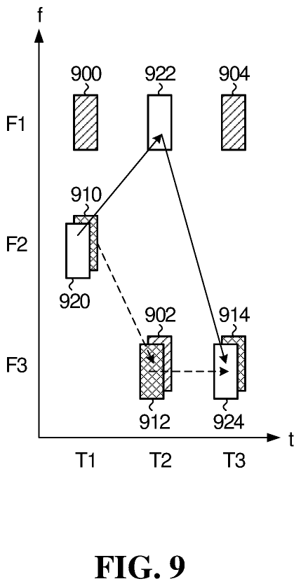

FIG. 9 shows an example of hopping patterns with three frequency locations F1, F2, F3 in the frequency domain and three time locations T1, T2, T3 in the time domain. The combination of a time location and a frequency location indicates a resource location. Each resource location, e.g. resource location 900 which is indicated by F1, T1, is shown by a box in FIG. 9. In this example, the resource location is specified in the frequency dimension by a frequency domain measure such as one or more subcarriers, resource blocks (RBs) or absolute value specified in Hz. The frequency location is a reference point to the resource location in the frequency domain, such as a lower edge, middle point or upper edge of a frequency domain measure in the frequency domain. The resource location is also specified in the time dimension by a time domain measure such as one or more OFDM symbols, slots, frames or absolute value specified in seconds and can be specified by New Radio (NR) frame structure. The time location is a reference point to the resource location in the time domain, such as a lower edge, middle point or upper edge of a time domain measure in the in time domain.

Multiple resource locations define a resource grid. In the example, of FIG. 9, there is a 3×3 grid of resource locations. A resource grid can be specified for a transmit beam, for a receive beam or both transmit and receive beams or other such physical resources.

As an alternative to defining locations hopping in frequency, frequency locations on one or multiple beams can be used for the resource locations. For example, different frequency locations on a given transmit beam may be used for the resource locations. In another example, a same frequency location on multiple beams represents or corresponds to a set of resource locations. In another example, multiple frequency locations of multiple beams can define the resource locations. Having multiple beams provides additional flexibility to define a resource grid. While the resource grid of FIG. 9 is based on physical resource dimensions of time and frequency, alternatively, a resource grid for hopping can be defined based on some other combination of physical resource dimensions, for example a combination of time, and one or more other dimensions/domains such as frequency, space (e.g. beam). The number of possibilities in each dimension (3 for each of time and frequency in the example of FIG. 9) is also implementation specific.

A resource grid can be defined that is specific to a single beam (beam specific) or common to several beams (beam group specific) or common to all the beams covering a cell (cell-specific). For example, the resource grid may be defined to be specific to a transmit beam where the transmitter creates multiple beams through a multiple antenna system. In another example, the resource grid is common to all transmit beams for an entire cell coverage area where the transmitter creates multiple beams through a multiple antenna system.

Two resource locations on the grid do not overlap in both the time domain and frequency domain. For example, resource 900 and 922 in FIG. 9 overlap in frequency F1, but not in time. The gap between two resource locations that are consecutive in frequency or time on the grid is zero (Hz in frequency or seconds in time) or more. For example, the time gap between resources 900,922 is ≥0 s, and the frequency gap between resources 900,910 is ≥0 Hz.

In the case that the gap between two resource locations is zero in time and/or frequency, they are adjacent (touching) in time or frequency or both. In the case that the gap is non-zero, they are not adjacent (non-touching) in time or frequency or both.

In some embodiments, frequency locations of a grid used for hopping can be defined within a single bandwidth part (BWP) or multiple BWPs or defined within a system bandwidth. In some embodiments, time locations of a grid used for hopping can be within one slot or multiple slots. A slot can be defined as one or more OFDM symbols of various sizes.

A hopping pattern can be defined based on the resource grid, a hopping pattern being a pattern of resource locations for wireless communications. Using a hopping pattern, a block of symbols carrying information bits are mapped to the pattern of resource locations in the resource grid. In the example of FIG. 9, three hopping patterns are shown as detailed below.

Frequency hopping is a specific example of hopping in which a block of symbols carrying information bits is mapped to a pattern of distinct frequency locations in the resource grid. In the example of FIG. 9, three hopping patterns are shown. A first pattern has resource locations 900, 902, 904; a second pattern has resource locations 910, 912, 914, and a third hopping pattern has resource locations 920, 922, 924. As such, for the example of FIG. 9, each hopping pattern is a pattern of resources that hops in the frequency domain. For the first hopping pattern, the symbols of a user are mapped to resource locations (F2, T1), (F1, T2), (F3, T3) which include three distinct frequency locations F2, F1, F3 over three time domain locations T1, T2, T3. Because the transmit symbols use multiple frequency locations, transmission is considered to hop in frequency. The mapped symbols can belong to a single information bit sequence, repetition of a single information bit sequence, multiple information bit sequences or repetition of multiple information bit sequences. When the time domain boundary of a single hopping pattern is constrained to within a single slot, such hopping can be defined as intra-slot frequency hopping. When the time domain boundaries of a single hopping pattern encompass multiple slots, such hopping can be defined as inter-slot frequency hopping. When the frequency domain boundary of a single hopping pattern is constrained to within a single BWP, such hopping can be defined as intra-BWP frequency hopping. When the frequency domain boundaries of a single hopping pattern encompass multiple BWPs, such hopping can be defined as inter-BWP frequency hopping. When the frequency domain boundaries of a single hopping pattern are constrained to within a single carrier, such hopping can be defined as intra-carrier frequency hopping. When the frequency domain boundaries of a single hopping pattern encompass multiple carriers, such hopping can be defined as inter-carrier frequency hopping. When the resource of a single hopping pattern is constrained to within a single beam, such hopping can be defined as intra-beam hopping. When the resource boundaries of a single hopping pattern encompass multiple beams, such hopping can be defined as inter-beam hopping.

There can be many hopping patterns defined within the same resource grid. In the example of FIG. 9, three hopping patterns are shown. Multiple transmissions can be transmitted simultaneously using hopping patterns defined over the same resource grid. The multiple transmissions can use the same hopping pattern or different hopping patterns and may originate from the same transmitter or different transmitters. As a result, in a given resource, there can be multiple transmissions leading to transmission collisions. Referring again to FIG. 9, a transmission using the first hopping pattern (F2,T1), (F1,T2), (F3,T3) will collide a simultaneous transmission using the second hopping pattern (F2,T1), (F3,T2), (F3,T3) in the third hopping location (F3,T3) while they do not collide each other in the first and second hopping locations.

When at least in one resource location of a hopping pattern, a transmission collides with some other transmission, it is considered non-orthogonal multiple access (NoMA). This is a significant contrast compared with frequency hopping in the absence of collision. When a transmission collides with another transmission, it creates an interference pattern for a given hopping pattern which does not exist in the absence of collisions. While frequency hopping results in frequency diversity and can improve performance, a collision pattern determines the interference power and interference pattern. Both aspects are important for the system to operate with good link performance for frequency hopping in a NoMA transmission scenario as compared to a transmission scenario with non-colliding transmissions.

Modulation of the symbols carrying information bits can be BPSK, π/2-BPSK, QPSK, π/4-QPSK, 16-QAM, 64-QAM, 256-QAM, 1024-QAM or other modulation scheme. The symbols mapped to a frequency location can use any waveform; specific examples include CP-OFDM or DFT-s-OFDM or other such as DFT-s-OFDM with frequency domain spectral shaping (FDSS) or offset QAM (OQAM).

To exploit frequency diversity and randomize interference from transmission collisions, a transmission hops to multiple frequency locations over multiples time instances. The same hopping patterns and resource grid may not be suitable for all propagation channel conditions (such as level of frequency selectivity) and for all levels of interference randomization required. For example, for highly frequency selective channel conditions, a lower number of frequency locations may be suffice to exploit the frequency diversity of the frequency propagation channel while a larger number of frequency locations may be needed for a less frequency selective channel. In another example, when a higher number of transmissions are colliding, a higher number of locations in the time domain may be required to randomize the interference while when a smaller number of transmissions are colliding, a smaller number of locations in the time domain may suffice.

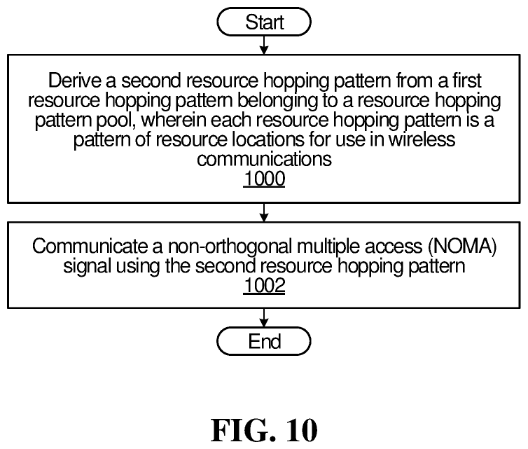

In accordance with an embodiment of the application, a system and method of providing and using hopping patterns suitable for different scenarios is provided that is efficient in terms of signaling and storage requirements. A flowchart of a method that can be performed by a network device or an apparatus such as a UE is shown in FIG. 10. Block 1000 involves deriving a second resource hopping pattern from a first resource hopping pattern belonging to a resource hopping pattern pool. Each resource hopping pattern is a pattern of resource locations for use in wireless communications. The second resource hopping pattern is different from the first resource hopping pattern in terms of the number of resource locations included in the resource hopping pattern and/or the resource locations included in the hopping pattern. The method continues in block 1002 with communicating a non-orthogonal multiple access (NOMA) signal using the second resource hopping pattern. Communicating can encompass transmitting and/or receiving.

The second hopping pattern is obtained/derived from the first hopping pattern. Similarly, a second resource hopping pattern pool can be derived from a first resource hopping pattern. However, it is generally not necessary to derive the second hopping pool in its entirety; individual second resource hopping patterns can be derived as needed.

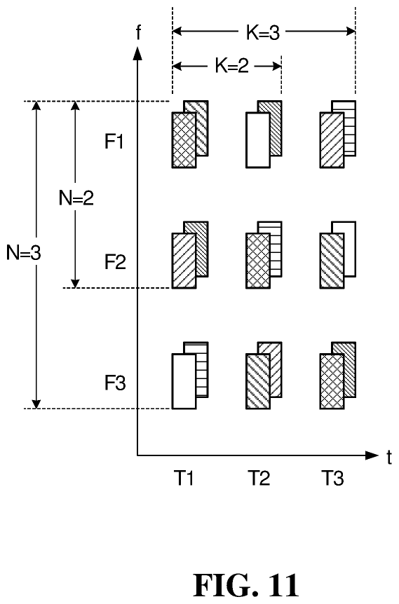

The second hopping pattern pool may use resource locations that are the same (or a subset of) as those used in the first hopping pattern pool. Alternatively, the second hopping pattern pool may use different resource locations. For example, referring to FIG. 11, consider a scenario in which there is a first pool having 6 hopping patterns and a second pool having 2 hopping patterns derived from the first pool. The interpretation of the first pool (of size 6) can be over resource locations such as 3 time locations & frequency locations. The interpretation of second pool can be over a different set of resource locations such 2 beams and 2 time locations. As such, there are two possibilities:

Interpretation of first and second pool on the same resource locations where the second pool use a sub-set of resource locations of the first pool;

Interpretation of the first pool and second pool can be over two different physical resource locations. This approach provides the flexibility for the transmitter or receiver or both to be configured/interpret appropriately to fit their capability, configuration, channel condition etc. In one example, the resource grid is defined over multiple frequency locations of a given beam when transmit/receive in FR1 and the resource grid is defined over the same frequency across multiple beams when transmit/receive in FR2. In another example, transmitter/receiver interpret the pool of n₁ locations for inter-BWP frequency hopping while a pool of different size n₂ (≠n₁) locations is used for intra-BWP frequency hopping where size n₂<n₁ or n₂>n₁. The same pool can be interpreted differently, for example, a pool is interpret for frequency locations of the same beam when a transmitter operates in FR1 while the same pool is interpreted for same frequency locations of multiple beams when the transmitter operates in FR2. In another example, a transmitter/receiver interprets a first pool of resource locations of size 3 over 3 beams while a second pool of resource locations of size 2 over 2 frequency locations is obtained from the pool of size 3.

In some embodiments, each resource location of the first resource hopping pattern has M physical resource dimensions, with Aᵢ possibilities in the ith dimension, where i=1, . . . , M, M>=2, Aᵢ>=2, and each resource location of the second resource hopping pattern has M physical resource dimensions, with Bᵢ possibilities in the ith dimension, where i=1, . . . , M, where all Bᵢ<=Aᵢ and at least one Bᵢ<Aᵢ. In other words, the number of possibilities in at least one of the dimensions is smaller for the derived hopping pattern compared to the original hopping pattern. The following are several examples:

### Example 1

M=2 physical resource dimensions are time and frequency;
A₁=3 possibilities in the time dimension;
A₂=3 possibilities in the frequency dimension;
B₁=2 possibilities in the time dimension; and
B₂=3 possibilities in the frequency dimension.

### Example 2

M=3 physical resource dimensions are time, frequency and space (e.g. beam number);
A₁=3 possibilities in the time dimension;
A₂=3 possibilities in the frequency dimension;
A₃=3 possibilities in the space dimension;
B₁=2 possibilities in the time dimension;
B₂=3 possibilities in the frequency dimension; and
B₃=1 possibilities in the frequency dimension.

Deriving the second resource hopping pattern from the first resource hopping pattern belonging to the resource hopping pattern pool may involve puncturing the first resource hopping pattern to produce the second resource hopping pattern. Puncturing involves omitting at least one resource location from the first hopping pattern.

Signaling can be used to indicate at least partly how to derive the second resource hopping pattern from the first resource hopping pattern. For example, the signaling could indicate to puncture the third time location. Signaling can also be used to indicate which hopping pastern to be used, for example by indicating an index of the first resource hopping pattern. The resource hopping pool may also be configured by signaling.

This approach will now be described by way of example. Consider a set of hopping patterns defined in a resources grid of size N locations in frequency and K locations in time. There are N K possible hopping patterns that can be defined in the resource grid, but as will be detailed below, in some cases not all possible hopping patterns are used. There are 6 hopping patterns shown in FIG. 11 with different shaded-patterns with K=3 and N=3, out of a total of 27 possible hopping patterns. The 6 hopping patterns can be considered as a hopping pattern pool, i.e. a set of hopping patterns that are available for use. This same pool is also shown in Table 1 below, where each hopping pattern is given a pattern index. For simplicity, resource label ‘F’ and in time domain label ‘T’ and the integer can be dropped. For example, P1 pattern can be simply written as 1,2,3 or P2 can be written as 1,3,2 (after dropping label ‘F’, ‘Ta’, a={1,2,3}. Signaling can be used between a network node and an apparatus such as a UE, that includes a dynamic indication of the pattern to be used from within a hopping pattern pool. For this example, the signaling needs to support a pool of size 6. The entire hopping pool is stored at the transmitter side. In a specific example, the network node signals the indication to a UE, and the UE receiving the indication can lookup up the hopping pattern from the stored pool, and use the pattern for transmission and/or receiving.

TABLE 1
A pool of hopping patterns

| Pattern index | Hopping pattern (F, T) |
|---|---|
| P1 | (F1, T1)(F2, T2)(F3, T3) |
| P2 | (F1, T1)(F3, T2)(F2, T3) |
| P3 | (F2, T1)(F1, T2)(F3, T3) |
| P4 | (F2, T1)(F3, T2)(F1, T3) |
| P5 | (F3, T1)(F1, T2)(F2, T3) |
| P6 | (F3, T1)(F2, T2)(F1, T3) |

With the hopping patterns in the pool of Table 1, all the hopping patterns are of length 3, including 3 frequency locations. Now, consider a situation in which only two frequency locations are required to achieve a desired performance. A length two hopping pattern will suffice in this situation. Hopping patterns of length 2 can be derived from the hopping patterns of length 3, for example by puncturing. More specifically, a second resource hopping pattern of length 2 can be derived from a first resource hopping pattern of length 3 belonging to the existing pool. As such, a hopping pattern pool with N=2 can be derived from a hopping pattern pool with N=3. With this approach, it is not necessary for the transmitter to store the hopping pool with N=2; patterns can be derived from the hopping pattern pool with N=3 as needed. While the savings realized due to not needing to store hopping patterns of length 2 is not significant, where the patterns are larger, the savings can be significant. For example, consider hopping patterns of length 20, this approach could be used to derive hopping patterns of any length shorter than 20, without the need to store a corresponding hopping pattern pool for each possible length shorter than 20.

An example of obtaining a shorter hopping pattern by using puncturing is described below. Table 2 shows a pool of hopping patterns with N=3, K=3. The pattern is indicated for the frequency location only, based on the assumption that for time, the pattern follows T1, T2, T3 in all cases. The superscript “K3N3” is to indicate the pattern belongs to the pool with N=3, K=3.

TABLE 2
Pool of hopping sequences of size N = 3, K = 3

| Pattern index | Pattern |
|---|---|
| P1^{(K3N3)} | 1, 2, 3 |
| P2^{(K3N3)} | 1, 3, 2 |
| P3^{(K3N3)} | 2, 1, 3 |
| P4^{(K3N3)} | 2, 3, 1 |
| P5^{(K3N3)} | 3, 1, 2 |
| P6^{(K3N3)} | 3, 2, 1 |

More generally, a hopping resource location may be indicated by a set of physical resources such as frequency location, time location, index to a transmit beam, index to a receive beam etc.

By puncturing the third time-location of a pattern in Table 2, a hopping pattern of length of 2 can be obtained as shown in Table 3 below. Here, puncturing the third time location means omitting the third resource location from each hopping pattern.

TABLE 3
Pool of hopping sequences of size N = 3, K = 2

| Pattern index | Pattern |
|---|---|
| P1^{(K2N3)} | 1, 2 |
| P2^{(K2N3)} | 1, 3 |
| P3^{(K2N3)} | 2, 1 |
| P4^{(K2N3)} | 2, 3 |
| P5^{(K2N3)} | 3, 1 |
| P6^{(K2N3)} | 3, 2 |

Similarly, by puncturing in frequency location 3, one can obtain hopping pattern of length 2 as shown in Table 4 below. Here, puncturing frequency location 3 means omitting any resource location from the pattern that has frequency location 3.

TABLE 4
Pool of hopping sequences of size N = 2, K = 2

| Pattern index | Patterns |
|---|---|
| P1^{(K2N2)} | 1, 2 |
| P2^{(K2N2)} | 2, 1 |

Puncturing the first frequency location 1 (i.e., F1), one can obtain a hopping pattern pool as shown in Table 5 below.

TABLE 5
Pool of hopping sequences of size N = 2, K = 2

| Pattern index | Patterns |
|---|---|
| P1^{(K2N2)} | 2, 3 |
| P2^{(K2N2)} | 3, 2 |

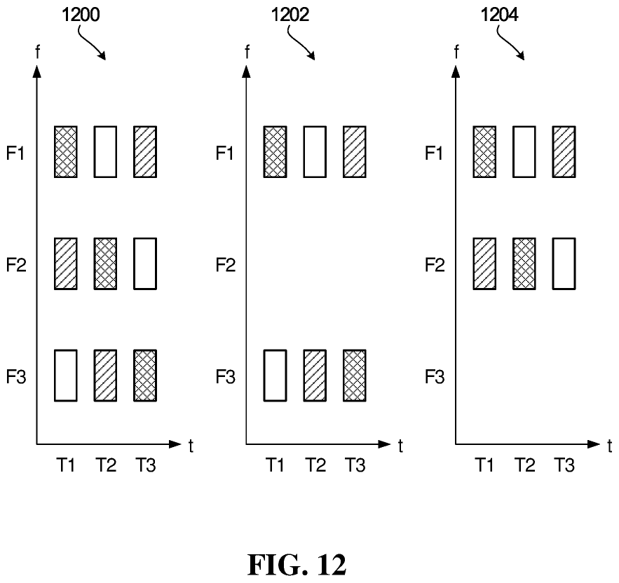

From Tables 4 and 5, it is clear that puncturing different locations may result in different hopping pattern pools and can have implications in the system performance. This is illustrated by the example shown in FIG. 12. Starting from pool 1200 with N=3, K=3, by puncturing the F2 location, the hopping pattern pool 1202 is obtained, and by puncturing the F3 location, the hopping pattern pool 1204 is obtained.

For hopping pattern pool 1202, the frequency locations are further apart than they were in the original hopping pattern pool 1200 and therefore, higher frequency diversity can be obtained as compared to hopping pattern pool 1204. If consecutive frequency locations are such that the inter frequency gap is zero (upper edge of the frequency location touches the lower edge of the next frequency location), by puncturing, a pool of frequency locations that are further away can be obtained. In another example, some frequency locations can be in a different BWP compared to other frequency locations. For example, F1, F2 may be within a first BPW while the F3 is in a second BWP different from the first. By puncturing F3 in the hopping pattern pool, the resources of the punctured pool can be limited to only the first BPW. Such flexibility is useful where different devices can operate in one or multiple BWPs. A device supporting multiple BWPs can use the pool 1200 or 1202, and pool 1204 can be used by a device supporting only a single BWP. In a similar manner, all three frequency locations can be in a single BWP and puncturing can result in pattern pools of different size within the same BWP.

Note that by puncturing recursively until only one frequency location is left, the result is the special case of sharing the same frequency by all devices; this is NoMA transmission without frequency hopping.

In general, puncturing one or more than one location only in time, only in frequency or both time and frequency can result in a shorter length hopping pattern and a pool with shorter length hopping patterns.

### Method on Obtaining a Hopping Pattern Pool

In another embodiment, a method of obtaining a hopping pattern pool is provided. This can be used as the input pool of patterns for the previously described embodiment, from which a shorter hopping pattern can be derived based on a hopping pattern in the hopping pattern pool. As discussed, the frequency hopping exploits the channel diversity while randomizing the interference. For a given number of frequency hop locations and numbers of hops in the time domain, there are many combinations of hopping patterns. For example, for an application with 3 frequency hop locations and 3 blocks in the time domain, there could be 27 possible distinct hopping patterns. However, such a large number of hopping patterns results in large signaling overhead and requires relatively a larger device memory/storage compared to a smaller number of hopping patterns. Therefore, it is desirable to support only few hopping patterns that provide good link performance.

A suitable hopping pattern that provides good interference randomization and exploit frequency diversity can be obtained by restricting the number of hops. A good hopping pattern for NoMA may have the following features:
avoid re-visiting a frequency location. In other words, within one hopping pattern, a given frequency location is included once and only once;
hop to a distant frequency location; in a little more strict sense, there is a non-zero gap between any two frequency hop locations; referring again to FIG. 12, the white space between frequency locations indicates a non-zero gap;
at least one frequency location included in a hopping pattern is also included in another hopping pattern at the same time position within the hopping pattern. In other words, at least one resource location is used in more than one hopping pattern.

Hopping patterns are defined such that within a single transmission using a hopping pattern, a UE hops from a first resource associated with a first frequency location to a second resource associated with a second frequency location such that the UE hops to any given frequency location only once, i.e., UE does not re-visit a frequency hop location, and the hopping resources do not overlap in frequency (or there is a non-zero gap in frequency hop locations), and at least in one resource/frequency hop location included in the hopping pattern is included in another hopping pattern so as to support NoMA transmission and allow collision, such that if the two hopping patterns are used simultaneously by respective UE there will be a collision in the resource/frequency hop location included in both hopping patterns.

Table 1 and Table 2 described above show 6 hopping patterns out of 27 hopping patterns possible from N=3,K=3 scenario. With this specific set of hopping patterns, two transmissions using P1 and P2 (chosen/assigned) will collide in the (F1,T1) resource. Similarly, each hopping pattern collides with at least one other hopping pattern. These patterns can be assigned to the transmitter by the network side (e.g. for uplink transmission, there can be a base station assigned hopping pattern signaled to a UE) or a transmitter may select a hopping pattern at random (e.g. for uplink transmission, a UE picks the hopping pattern at random) or deterministic manner (e.g. the hopping pattern may be selected based on some function, such as mod(UE_ID, pool size) where mod is the modulo operation). When two or more transmitters choose or are assigned the same hopping pattern, such transmissions can collide in all resources.

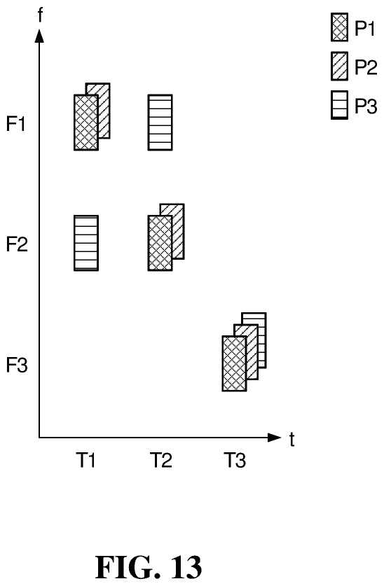

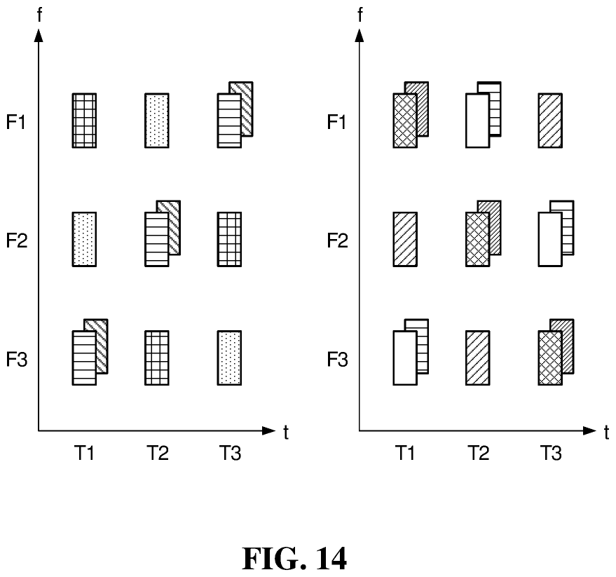

Hopping patterns P1 and P3 in Table 1 are shown in FIG. 13. There are two transmissions using the P1 pattern such that they collide in all resources. In addition, the P1 pattern collides with the P3 pattern in the (F3, T3) resource. In this case, the (F3, T3) resource has 3 transmissions simultaneously colliding each other.

There are patterns in the pool that are orthogonal to each other. If two patterns do not collide in any resource, they are considered orthogonal. For example, P1 and P4 (Table 1) do not collide in any of the resources. Similarly P5 does not collide with both P1 and P4. As such P1, P4 and P5 can be considered mutually orthogonal to each other. There are two sets/groups of mutually orthogonal patterns in Table 1, namely the group of patterns (P1, P4, P5), and the group of patterns (P2, P3, P6).

Another property of a second hopping pool containing truncated patterns derived from a first hopping pool is the fact that the truncated patterns have the same property of non-revisiting a frequency location. For example, the patterns in Table 3 (Truncated in time domain) and Table 4, 5 (truncated in frequency) do not revisit any frequency location. Furthermore, mutually orthogonal patterns exist in the derived hopping pattern pools. For example, P1^{(K2N3)}, P4^{(K2N3)}, P5^{(K2N3)} forms a mutually orthogonal group of hopping patterns while P2^{(K2N3)}, P3^{(K2N3)}, P6^{(K2N3)} forms another mutually orthogonal group of hopping patterns, each group of size 3 (number of patterns in the group). In Table 4 and Table 5, there are two mutual orthogonal groups with each group having one pattern. More generally, orthogonal groups of hopping patterns can be defined within any given hopping pattern pool.

The symbols mapped on to the resources indicated by a hopping pattern are constellation symbols that carry the information bits of the transmitter. Such constellation symbols can carry independent symbols of a single frame/packet/segment or more than one frame/packet/segment. Within one hopping pattern, repetition of symbols can be transmitted/mapped. For example, within the hopping pattern, resources in the hopping pattern at T1 and T2 can be used to transmit the same symbol(s) (repetition of the symbols of T1). In an alternative method, the symbols transmitted using a hopping pattern could be symbols from a hybrid automatic repeat request (HARQ) process, where some of the symbols contain incremental redundancy or chase combining symbols. In another alternative, the symbols transmitted using a hopping pattern can be independent symbols of the same frame. In this case, a first fragment/segment/portion of a transmission symbol frame is mapped to T1 resources and another to T2 resources etc.

Symbols mapped to a hopping pattern may be symbols from an underlying NoMA signal. For example, symbols can be spread symbols. Spread symbols can be symbol spread with linear spreading or non-linear spreading. In linear spreading, spread symbols have a linear relationship among them. For example, a symbol s₁ spread with spreading sequence [1,−1] produces the symbol sequence [s₁, −s₁]. On other hand, in non-linear spreading, the relationship between the spread symbols is associated with the mapping bits. For example, bits 00, 01, 10 may map to symbols s₁, s₂, s₃ and bit sequence 010 spread to 0110 (by duplicating the middle bit) and mapping, symbol sequence s₂, s₃ is obtained. As such the relationship of the symbols is defined in the bit domain. Non-linear spreading may be referred to as multi-dimensional modulation as well. As such by defining a bits to symbol mapping (in a table or constellation), non-linear spreading can be achieved. The spreading may be sparse spreading or non-sparse spreading. In sparse spreading, spreading involves zero symbol (a symbol ‘0’ with zero power). For example, symbol si sparse spread by sparse sequence [1, 0] produces symbol sequence [s₁, 0]. Sparse spreading may also refer as sparse mapping. The symbols may be scrambled symbols. For example, symbol sequence [s₁, s₂] scrambled by scrambling sequence [1,−1] produces the symbol sequence [s₁,−s₂]. Other symbol domain operations such as symbol interleaving can be performed (changing the location of the symbols, symbol permutation). The symbols may be generated after bit domain process such as bit interleaving, bit repetition, bit permutation, bit scrambling. A NoMA signal may be produced by combination of bit or symbol domain operations. For example, linear spreading together with bit interleaving may produce a NoMA signal. In another example, symbol spreading with symbol scrambling may produce a NoMA signal. In yet another example, bit interleaving and bit scrambling may produce a NoMA signal. A combination of symbol domain, bit domain or both may produce a NoMA signal. Such production of a NoMA signal may corresponds to a NoMA scheme. As a result, the symbols mapped can come from a NoMA scheme such as SCMA (non-linear spread symbols), MUSA/NOCA (linear spread symbols), sparse spreading (IGMA, PDMA, LDS), bit domain processed (IDMA, LCRS), scrambling (eg. RSMA) or power domain based. As such, the symbols mapped to resources of a hopping pattern can have an association to a multiple access (MA) signature. Such a MA signature or NoMA signal can help differentiate the collision at the receiver side. Such NoMA signals or NoMA schemes can improve the system performance by better controlling the interference generated by transmission collisions.

The hopping granularity in the time domain or frequency domain are configuration parameters of the system. For example, the hopping granularity in the time domain may be several symbols, a single slot, or multiple slots. The hopping granularity in the frequency domain may, for example, be several subcarriers, a single resource block (RB), or multiple RBs, a single BWP or multiple BWPs, within a system or carrier BW.

### Overloaded Orthogonal Hopping

In some embodiments, in order for a transmission to exploit diversity and randomize interference while reducing the signaling overhead further, hopping patterns are restricted to a mutually orthogonal group. For example, continuing from the Table 1 example, two orthogonal groups are given in Table 6(a) and Table 6(b).

TABLE 6(a)

| Pattern | F |
|---|---|
| P1 | 1, 2, 3 |
| P4 | 2, 3, 1 |
| P5 | 3, 1, 2 |

TABLE 6(b)

| Pattern | F |
|---|---|
| P2 | 1, 2, 3 |
| P3 | 2, 3, 1 |
| P6 | 3, 1, 2 |

Patterns/sequences in Table 6 (a) are orthogonal to each other, and similarly the patterns/sequences in Table 6 (b) are orthogonal to each other. If transmission is limited to one of the orthogonal groups, then no two patterns collide each other. With orthogonal hopping pattern overloading, on a given pattern, more than one transmission is enabled. As such, multiple transmissions share the same hopping pattern. This scheme is referred to herein as overloaded orthogonal hopping transmission.

An example of a method making use of overloaded orthogonal hopping transmission can be summarized as follows. Within a single transmission, a transmitter hops from a first resource associated with a first frequency location to a second resource associated with a second frequency location in accordance with a hopping pattern such that the transmitter hops to any given frequency location only once, i.e., UE does not re-visit a frequency hop location, and the hopping resources do not overlap in frequency (or more strictly, non-zero gap in frequency hop locations). Another UE can transmit using the first and second resources such that there is a collision with the other UE on both the first and second resources. However, another UE cannot transmit using only one of the first and second resources with partial collision.

MA Signature Assignment with Hopping

When the modulated symbols (carrying information bits) of multiple devices are mapped to a resource, transmissions collide each other. A transmitter can be associated with an MA signature. The use of MA signatures helps colliding transmissions to be separated at the receiver side. There are many NoMA schemes that uses different techniques to define an MA signature. Such methods include linear spreading (E.g. MUSA/NOCA/CDMA), non-linear spreading (E.g. SCMA), sparse spreading/mapping (E.g. IGMA, LDS, PDMA), bit level processing such as bit interleaving, bit scrambling (E.g. LCRS, IDMA), symbol level scrambling (E.g. RSMA), symbol interleaving (E.g. IGMA).

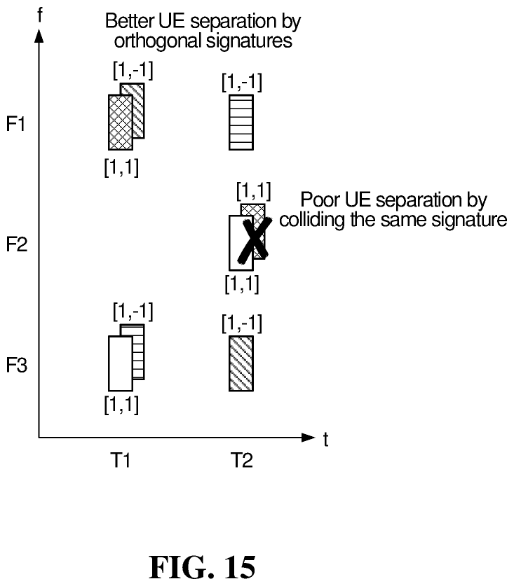

In one approach, one or more MA signature(s) are assigned to a transmission (or device/UE). An example is shown in FIG. 15, where each transmission has an associated linear spreading sequence that is either [1,1] or [1,−1]; this is specific examples of a set of orthogonal MA signatures. As shown in FIG. 15, in the (F2, T2) resource, two transmissions with the same signature [1, 1] collide with each on the same resource other leading to poor link performance. Note that each of the two transmissions with the signature [1, 1] that collide in (F2, T2) also collides in the T1 location with another transmission with signature [1, −1] which has good multi-user separation because the signatures are different. For example, in the (T1, F3) location, two transmissions collide with each other with linear spreading sequences [1, 1], [1, −1] which are orthogonal signatures (because [1,1], [1,−1] are orthogonal sequences (inner product or correlation is zero [1,1] [1,−1]T=0). Similarly, in the (T1, F1) resource, there is good signal separation. However, in the (T2, F2) resource, such an assignment can lead to poor signal separation. This situation can occur in both grant free (NoMA signature is selected at random) or assigned (grant based) scenarios and for any type of MA signatures including linear spreading, non-linear spreading, scrambling, sparse mapping, bit-level processing based etc. Two methods are provided in order to improve the signature separation in methods that also feature the use of hopping patterns.

### Method 1: Re-Assignment of MA Signature to Orthogonal Hopping Patterns

Consider a scenario in which a MA signature pool includes two MA signatures s₁=[1,1] and s₂=[1,−1] based on linear spreading. More generally, a MA signature pool may be defined using one or more techniques such as sparse spreading, non-linear spreading, linear spreading, scrambling or other methods. There are 6 hopping patterns shown in Table 7. In both Table 7 and 8, the column ‘i’ shows alternative ways to assign the signatures to hopping locations. This way, whether i=0 or i=1 configuration is used, a better multi-user separation is achieved. Moreover, when the number of UEs to be supported is larger, both i=0 and i=1 can be used. Therefore, index can be used in two different ways:
serve as alternative ways to perform signature assignment (i.e., if the number UEs to be supported is small, use either i=0 or i=1 assignment);
serve more UEs in the system dynamically (i.e., if the number of UEs to be supported is large, configure to use both i=0, i=1).
   Note that in the provided examples, only two options, i.e., ‘i=0’, ‘i=1’ are shown because the signature pool is s1=[1,1], s2=[1,−1]. However, the number of options could be larger in a system with more signatures. For example, instead of s1=[1,1], s2=[1,−1], in a different system, s1=[1,1], s2=[1,−1], s3=[1,j], 54=[1,−j] where j=sqrt(−1), four different assignment options exist, and it would be possible to use ‘i’ one option out of ‘0,1,2,4’ or all four options to support a much larger number of UEs.

The hopping patterns can be grouped by mutually orthogonal patterns as described previously, i.e., group 1 includes P1, P4, P5 and group 2 having P2, P3, P5. As mentioned earlier, hopping patterns within one group do not collide each other. However, a pattern in one group may collide with a pattern in another group.

TABLE 7
Group based signature assignment

| | | |
|---|---|---|
| Pattern | Frequency | MA Signature assignment |

| index | Hopping Pattern | i = 0 | i = 1 |
|---|---|---|---|
| P1 | 1, 2, 3 | s₁ | s₂ |
| P2 | 1, 3, 2 | s₂ | s₁ |
| P3 | 2, 1, 3 | s₂ | s₁ |
| P4 | 2, 3, 1 | s₁ | s₂ |
| P5 | 3, 1, 2 | s₁ | s₂ |
| P6 | 3, 2, 1 | s₂ | s₁ |

As shown in the table, the same signature is assigned to the patterns of a given group. For group 1 (i.e., patterns P1, P4, P5), signature s₁ and for group 2 (i.e., patterns P2, P3, P6), signature s₂ is assigned. As a result, non-colliding patterns share an MA signature. Therefore, there are 6 hopping patterns corresponding to i=0. This approach can be applied generally to any hopping pattern pool.

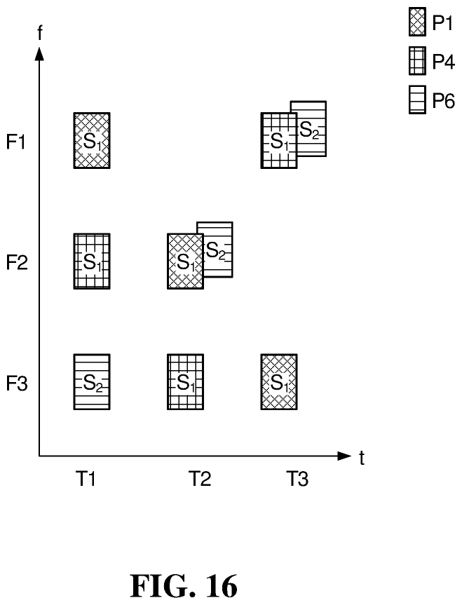

As shown in FIGS. 16, P1 and P4 are assigned s₁ while P6 is assigned s₂. As P1 and P4 do not collide, there is no need of MA signature domain signal separation. P1 and P6 collide in (F2, T2) resource and signals are separated by the signatures. Similarly, one can use the signature assignment indicated by i=1 in Table 7. Furthermore, when the number of supported transmissions increases (e.g. a large number of active UEs or potentially active UEs), both i=0 and i=1 signature assignments together with the hopping patterns can be used for better multi-user separation while providing the advantages of hopping. With this approach, two transmissions sharing the same hopping pattern are separated in MA signature domain. For example, one transmission using P1 can use s₁ while other transmission can use s₂. As such, the supported number of transmissions can be dynamically adjusted based on the number of transmissions the system needs to support.

For example, in a grant based transmission, hopping pattern or MA signature or both are assigned to a transmission; with the example above, 6 hopping pattern and signature assignment pairs (by i=0 or i=1) can be supported. Alternatively, in a grant based transmission, hopping pattern or MA signature or both are assigned to a transmission supporting 12 hopping and signature assignment pairs by both i=0 and i=1. In a grant free transmission, hopping pattern or MA signature or both are picked by the transmitter, for example in a random manner; the transmitter can pick one out of 6 potential hopping and signature assignment pairs from i=0 or i=1. At a given point, whether to use an MA signature with i=0 (or i=1) only or both i=0 and i=1 may be indicated by DCI, RRC or MAC-CE type of signaling.

In the example, the MA signature pool consists of only two signatures, namely s₁=[1,1] and s₂=[1, −1]. In a system where more transmissions may exist, a larger signature pool can be used. For example, a MA signature pool such as s₁=[1,1], s₂=[1,−1], s₃=[1,j] and s₄=[1, −j] where j=\sqrt{−1} can be used. As a result, more transmissions can be supported where a larger signature pool is used, where a MA signature is re-assigned to mutual orthogonal hopping patterns. At a given point, what kind of MA signature pool to be used may be indicated by DCI, RRC or MAC-CE type of signaling.

Method 2: Simultaneous MA Signature Hopping with Frequency Hopping

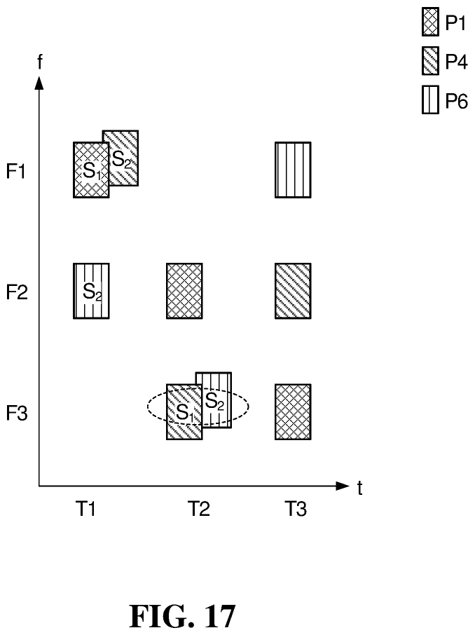

Consider a scenario shown in FIG. 17 where P1, P2 use signature s₁,s₂ in resource (F1, T1) and P4 uses signature s₂ in resource (F2, T1). Consider MA signature pool s₁=[1,1] and s₂=[1,−1] based on linear spreading.

Because of the signal separation by MA signatures which are orthogonal to each other in resource (F1, T1), good separation from interference (cause by collisions) is expected. However, at (F3, T2), P2 collide with P4. At T1, P4 or P2 both use signature s₂. If both P4 and P2 continue to use the same MA signature used in T1 (i.e., s₂) at T2, both transmissions will collide with the same MA signature leading to poor separation from the interference. Instead, as shown in FIG. 17, P2 transitions to signature s₁ in (F3, T2) resource. As such, during the resource (F1, T1) and (F3, T2) colliding transmissions have better separation by at least one transmission hopping to another MA signature in the next hop (P2 hopping the MA signature in FIG. 17). The use of different MA signatures within a single transmission is referred to herein as MA signature hopping. Alternatively, P4 can hop the MA signature while P2 remains in the same MA signature. An example of this approach of hopping MA signature together with frequency hopping is shown in the Table 8. In the table, a MA signature hopping pattern [s₁, s₁, s₁] for frequency hopping pattern 1,2,3 means that s₁ is used with frequency location 1 in the first time location, s₁ is used with frequency location 2 in the second time location, and s₁ is used with frequency location 3 in the third time location.

TABLE 8
MA signature hopping with frequency hopping

| Frequency | |
|---|---|
| Hopping | MA signature hopping pattern |

| Pattern | Pattern | I = 0 | I = 1 |
|---|---|---|---|
| P1 | 1, 2, 3 | [s₁, s₁, s₁] | [s₂, s₂, s₂] |
| P2 | 1, 3, 2 | [s₂, s₁, s₁] | [s₁, s₂, s₂] |
| P3 | 2, 1, 3 | [S₂, s₂, s₂] | [s₁, s₁, s₁] |
| P4 | 2, 3, 1 | [S₁, s₂, s₁] | [s₂, s₁, s₂] |
| P5 | 3, 1, 2 | [s₁, s₁, s₂] | [s₂, s₂, s₁] |
| P6 | 3, 2, 1 | [s₂, s₂, s₂] | [s₂, s₂, s₂] |

As can be seen from the Table, in a given frequency hopping pool such as the pool shown in Table 8, MA signatures have been assigned such that in colliding resources a good separation is achieved through MA signature hopping. As such, for at least one hopping pattern, the MA signature hops. The MA signature may remain constant within a resource. Alternatively, MA signature can hop within a resource as well, however, with good signal separation through MA signature. In the example shown in Table 8, at a given resource only two patterns collide for i=0 (or i=1). As a result, colliding hopping patterns can alternate between s₁ and s₂ within the colliding resource to maintain good separation through MA signatures.

An alternative MA signature hopping assignment to frequency hopping is given for i=1. Moreover, for supporting a larger number of hopping patterns with MA signature assignment, both i=0 and i=1 can be used. At a given point, whether to use signature hopping with i=0 (or i=1) only or both i=0 and i=1 may be indicated by DCI, RRC or MAC-CE type of signaling. Furthermore, by using a larger MA signature pool a larger number of transmissions can be supported. As such by combining a different number of MA signature pools with frequency hopping, the number of simultaneously supported transmissions can be adjusted in a more dynamic manner. At a given point, what kind of MA signature pool to be used may be indicated by DCI, RRC or MAC-CE type of signaling.

To improve performance in a system that does not use frequency hopping, signature hopping can be applied, where within one transmission, a transmitter uses multiple MA signatures. This has higher probability of randomizing interference by minimizing the probability of colliding transmissions consistently with the same signature. However, the use of signature hopping with frequency hopping is different than signature hopping without frequency hopping. When MA signature hopping is used together with frequency hopping, signature assignment needs to also consider the assignment of hopping patterns which may collide within the transmission resources. In accordance with the provided approach, for at least for one hopping pattern, the MA signature hops from one MA signature to another when the transmission hops from one frequency to another in accordance with a hopping pattern. The MA signature hopping is aligned with the frequency hopping. Moreover, within a resource when two hopping patterns are colliding, MA signature assignment needs to consider the assignment of the MA signature for other patterns, such that distinct MA signatures are used for two hopping patterns where the two hopping patterns collide. This improves the ability to perform signal separation in the presence of hopping pattern collisions through the use of MA signatures.

### Concatenating and Appending Pools

In some embodiments, in order to support more frequency locations or time locations, hopping patterns can be concatenated. An example will be described with reference to Table 9 below.

TABLE 9(a)

| Pattern | Frequency |
|---|---|
| index | Hopping Pattern |
| P1 | 1, 2, 3, 1, 2, 3 |
| P2 | 1, 3, 2, 1, 3, 2 |
| P3 | 2, 1, 3, 2, 1, 3 |
| P4 | 2, 3, 1, 2, 3, 1 |
| P5 | 3, 1, 2, 3, 1, 2 |
| P6 | 3, 2, 1, 3, 2, 1 |

TABLE 9:
Concatenated frequency hopping pools

| Pattern | Frequency |
|---|---|
| index | Hopping Pattern |
| P1 | 1, 2, 3, 4, 5, 6 |
| P2 | 1, 3, 2, 4, 6, 5 |
| P3 | 2, 1, 3, 5, 4, 6 |
| P4 | 2, 3, 1, 5, 6, 4 |
| P5 | 3, 1, 2, 6, 4, 5 |
| P6 | 3, 2, 1, 6, 5, 4 |

For example, a hopping pattern can be repeated in the time domain, Table 9(a) shows a hopping pattern over 6 time domain locations and 3 frequency locations obtained by repeating a hopping pattern over 3 time domain locations and 3 frequency locations. Alternatively, a hopping pattern can be repeated in the time domain, but in a new set of frequency locations. Table 9(b) shows a hopping pattern over 6 time domain locations and 6 frequency locations, in which the second 3 time domain locations have been obtained by replacing frequency locations 1,2,3 with frequency locations 4,5,6, respectively.

### Indicating Hopping Pattern

The hopping patterns need to be known to the transmitter along with other parameters such as waveform (e.g. CP-OFDM, DFT-s-OFDM), hopping patterns, hopping pattern puncturing, MA signature, MA signature assignment to hopping patterns, modulation, code rate (MCS), resource and resource grid configuration, pattern pool concatenation etc. Some of these parameters may be known/fixed and others may need to be signaled. In some embodiments, a grant-based type of transmission is employed, and the hopping patterns are indicated/signaled to the transmitter through signaling such as RRC, DCI or MAC-CE or a combination thereof. In some embodiments or scenarios, the signaling can be direct. For example, the transmitter is explicitly indicated to use a certain index of the hopping pattern pool (e.g. the index to a specific hopping pattern within a hopping pattern table such as Table 1). In another embodiment or scenario, a transmitter computes or obtains or derives the hopping pattern to be used based on available information. For example, an assigned MA signature provide information regarding the hopping pattern(s) to be used and therefore, based on the MA signature assignment or signaling, a hopping pattern can be derived or obtained.

Alternatively, the hopping pattern may be obtained or chosen or selected by the transmitter without reliance on signaling. For example, a transmitter may obtain a pseudo random number l and choose the hopping pattern mod(1, L) where L is the number of hopping patterns in the pool and mod(a, b) represents modulo operation.

In some embodiments, a transmitter is indicated a group of patterns (such as the two mutually orthogonal groups of patterns of Table 1) to be used through signaling such as RRC, DCI or MAC-CE or combination thereof. The transmitter obtains a pseudo random number l and chooses the hopping pattern mod(l, L_{g}) where L_{g} is the number of hopping patterns in the group of patterns.

In some scenarios, the use of MA signature hopping is implied based on the waveform being used. For example, signature hopping may be implemented only for a DFT-s-OFDM waveform scenario, in which case use of such waveform implies the use of MA signature hopping, while use of another waveform implies no MA signature hopping.

In some scenarios, the transmitter may support multiple hopping pattern pools and the use of a particular pool is indicated to the transmitter explicitly. In some other embodiments, a hopping pattern pool is implied. For example, resource grid configuration may provide the information regarding which frequency hopping pool to be used.

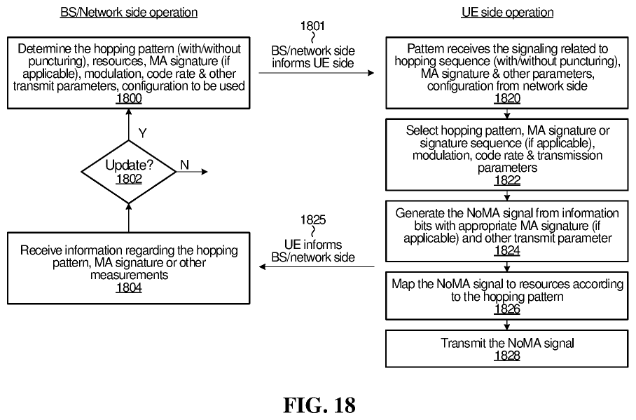

FIG. 18 is a flowchart of an example method of uplink NoMA transmission including signaling. The flowchart shows functionality for both the network side operation and the UE side operation. At the network side, in block 1800, a network node, such as a base station, determines the hopping pattern (with or without puncturing or concatenation), resource information (for example, resource and resource grid information, which might include a resource grid specific to a beam, group of beams or a cell specific resource grid, information on BWP), hopping pool interpretation (for example, for each pool the hopping pool to be defined over beam, frequency, other resources etc) MA signature (if applicable), modulation, code rate, and other transmit parameters, configurations to be used, such as N, K. At 1801, the network node transmits signaling to inform the UE side. At 1820, the UE receives the signaling.

At 1822, the UE selects a hopping pattern, MA signature or signature sequence (if applicable), modulation, code rate and transmission parameters. Alternatively, any or all of these may be dictated by the signaling received from the network side. In block 1824, the UE generates a NoMA signal carrying information bits with appropriate MA signature (if applicable) and other transmit parameters. In some embodiments, block 1825 is included, in which the UE side informs the network side of certain information regarding the selected hopping pattern, MA signature or other measurements to the network side. The network side at 1804, receives such information and may update (yes path block 1802) the frequency hopping or other parameters of the transmissions. Continuing with the UE side, the UE in block 1826 maps the NoMA signal to resources according to the hopping pattern, and in block 1828, the UE transmits the NoMA signal.

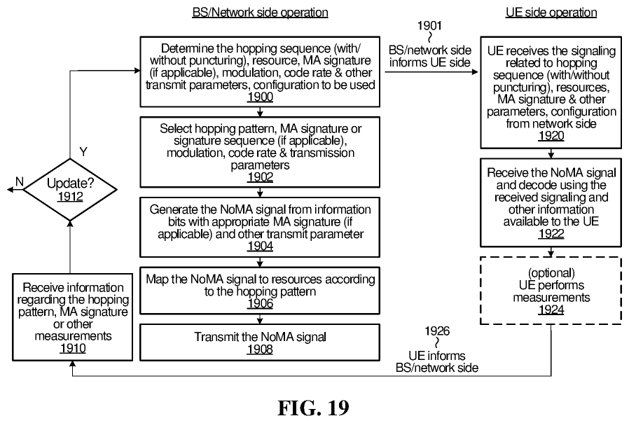

In a similar manner, hopping can be supported through signaling in downlink transmission. A flowchart of an example method is shown in FIG. 19. At the network side, in block 1900, a network node, such as a base station, determines the hopping pattern (with or without puncturing or concatenation), resource information (for example, resource and resource grid information, which might include a resource grid specific to a beam, group of beams or a cell specific resource grid, information on BWP), hopping pool interpretation (for example, for each pool the hopping pool to be defined over beam, frequency, other resources etc), MA signature (if applicable), modulation, code rate, and other transmit parameters, configurations to be used, such as N, K. At 1901, the network node transmits signalling to inform the UE side. At 1920, the UE receives the signalling. At 1902, the network node selects a hopping pattern, MA signature or signature sequence (if applicable), modulation, code rate and transmission parameters. In block 1904, the network node generates a NoMA signal carrying information bits with appropriate MA signature (if applicable) and other transmit parameters. In block 1906, the network node maps the NoMA signal to resources according to the hopping pattern, and in block 1908, the network node transmits the NoMA signal.

At the UE side, the NoMA signal is received in block 1922, and the UE decodes using the received signalling and other information available to the UE. In some embodiments, block 1924 is included, which involves performing measurements; these are fed back to the network at 1926. The network side at 1910 receives such information and may update (yes path block 1912) the frequency hopping or other parameters of the transmissions. For example, along with HARQ, UE may indicate the hopping related details along with data reception ACK/NACK information. The BS side, upon receiving such optional information from UE side, may decide to update the downlink hopping parameters or configurations.

In another embodiment, one or more of the approaches described herein is applied to sidelink communications. In such a scenario, a device directly communicates to another device. The BS/network side informs both the transmitter and receiver of the hopping details and parameters similar to DL or UL transmit scenario. The receiving side may perform certain measurements and optionally informs the BS/network side to which the BS/network side determines whether the hopping configurations, parameters should be updated.

A transmission using one of the provided hopping configurations, transmission parameters etc. can happen while the transmitter is in any one of RRC states such as RRC_INACTIVE (inactive state) or RRC_CONNECTED (connected state) or RRC_IDLE (idle state) or while the transmitter is transitioning from one RRC state to another. Configuration and/or transmission parameters can be signaled while the transmitter is in such state or while the transmitter is transitioning from one state another. For example, transmission or signaling can happen while the transmitter is transitioning from connected state to inactive state (i.e., release with suspend).

The embodiments may have some of the following advantages:
flexibility to adapt hopping patterns by puncturing/pruning: Adjust the supported number of symbol blocks (time-domain) and supported number of frequency hop locations (frequency-domain) flexibly with little overhead;
dynamically configure the hopping pool to be used depending on the transmitter/receiver capability, channel condition, frequency of operation (lower frequency such as FR1 or higher frequency mmWave/THz region such as FR2) configuration, deployment scenario, target performance etc.;
interpret the hopping pool according to the transmitter/receiver capability, channel condition, deployment scenario, frequency of operation, target performance;
exploit frequency diversity and provide flexibility with resource allocation: Non-revisiting frequency hop location and adjusting the gap between frequency hop locations can be used to provide a flexible approach for resource allocation while improving the link performance;
sufficient interference randomization with good channel estimation performance at a reasonable pilot overhead;
better multi-user separation: Simultaneous MA signature and frequency hopping and an MA signature re-assignment to multiple orthogonal frequency hopping patterns improves transmission separation from interference;
unified design for grant-based (i.e., UE assigned hopping) and grant-free (i.e., UE random selection);
flexible MA signature pool size: Frequency hopping with MA signature extension support a flexible number of transmissions;
high spectral efficiency through NoMA with good multi-user separation;
flexibility to achieve high spectral efficiency keeping the signaling overhead reasonably low: Maximize diversity/interference randomization through the proposed hopping method. Moreover, overloaded orthogonal frequency hopping can be used to provide a low overhead signaling scheme for frequency hopping.

Various embodiments may include one or a combination of the following features:
shorter length hopping patterns obtained by puncturing/truncating/pruning a hopping pattern. In other words, hopping patterns having a size less in K or N or both are obtained by pruning hopping patterns of size more than or equal to K and N. A hopping pattern pool of a small number of frequency or time hop locations is obtained by eliminating/dropping/removing corresponding hop locations from a pattern;
within a single transmission, a UE hops from a first resource associated with a first frequency location to a second resource associated with a second frequency location such that the UE hops to any given frequency location only once, i.e., UE does not re-visit a frequency hop location, and the hopping resources do not overlap in frequency (or non-zero gap in frequency hop locations), and at least in one resource/frequency hop location, more than one UE transmits (NoMA);
at least for one hopping pattern, the MA signature hops simultaneously with frequency hopping (and the MA signature can remain unchanged within the block of the symbols of a given resource block/hop location). In an alternative approach, an MA signature is mapped to more than one hopping pattern which are orthogonal to each other;
associated signaling/indication from BS/network side to UE side(s) are provided for uplink, downlink and sidelink transmission scenarios.

The provided embodiments can be used in uplink, downlink and side link in cellular systems such as 5G and beyond. It can also be used in other systems such as satellite communication systems, non-terrestrial communication system, wi-fi etc.

Numerous modifications and variations of the present disclosure are possible in light of the above teachings. It is therefore to be understood that within the scope of the appended claims, the disclosure may be practiced otherwise than as specifically described herein.

What is claimed is:

1. A method, wherein the method comprising:
deriving a second resource hopping pattern from a first resource hopping pattern belonging to a resource hopping pattern pool, wherein each resource hopping pattern is a pattern of resource locations for use in wireless communications, wherein the second resource hopping pattern is different from the first resource hopping pattern in terms of at least one of:
number of resource locations included in the resource hopping pattern;
resource locations included in the hopping pattern;
communicating a non-orthogonal multiple access (NoMA) signal using the second resource hopping pattern.

2. The method of claim 1 wherein:
where each resource location of the first resource hopping pattern has M physical resource dimensions, with Aᵢ possibilities in for the i-th dimension, where i=1, . . . , M, M>=2, Aᵢ>=2, and each resource location of the second resource hopping pattern has M physical resource dimensions, with Bᵢ possibilities for the i-th dimension, where i=1, . . . , M, where all Bᵢ<=Aᵢ and at least one Bᵢ<Aᵢ.

3. The method of claim 2 wherein the M physical resource dimensions comprise time and at least one of frequency or space.

4. The method of claim 1 wherein deriving the second resource hopping pattern from the first resource hopping pattern belonging to the resource hopping pattern pool comprises:
puncturing the first resource hopping pattern to produce the second resource hopping pattern, wherein puncturing comprises:
omitting at least one resource location from the first hopping pattern.

5. The method of claim 1 further comprising communicating signalling that at least partly indicates how to derive the second resource hopping pattern from the first resource hopping pattern.

6. The method of claim 1 further comprising communicating signalling indicating an index of the first resource hopping pattern.

7. The method of claim 1 further comprising communicating signalling to configure the resource hopping pool.

8. The method of claim 1 further comprising communicating signalling indicating a multiple access (MA) signature or a pattern of MA signatures, wherein communicating using the modified resource hopping pattern comprises using the indicated MA signature or pattern of MA signatures.

9. The method of claim 1 wherein each resource hopping pattern of the resource hopping pattern pool hops between frequency locations that belong to a set of non-adjacent frequency locations, and no frequency location of the set appears twice in any resource hopping pattern.

10. The method of claim 1, executed by a network device, wherein:
the pool comprises at least one group of resource hopping patterns, wherein within each group of resource hopping patterns the resource hopping patterns are orthogonal to each other;
the method further comprising assigning, by the network device, the same hopping pattern to multiple apparatus.

11. The method of claim 10, executed by a network device, wherein:
the pool comprises at least one group of resource hopping patterns, wherein within each group of resource hopping patterns the resource hopping patterns are orthogonal to each other, and wherein a respective different MA signature is associated with each group of resource hopping patterns;
the method further comprising:
assigning, by the network device, a resource hopping pattern, the resource hopping pattern being one of the resource hopping patterns of one of the at least one group, and assigning the respective MA signature of the one of the at least one group.

12. The method of claim 10 further comprising:
assigning, by the network device, an MA Signature hopping sequence that hops simultaneously with resource hopping.

13. An apparatus comprising a processor and memory, the apparatus configured to execute a method comprising:
deriving a second resource hopping pattern from a first resource hopping pattern belonging to a resource hopping pattern pool, wherein each resource hopping pattern is a pattern of resource locations for use in wireless communications, wherein the second resource hopping pattern is different from the first resource hopping pattern in terms of at least one of:
number of resource locations included in the resource hopping pattern;
resource locations included in the hopping pattern;
communicating a non-orthogonal multiple access (NoMA) signal using the second resource hopping pattern.

14. The apparatus of claim 13 wherein deriving the second resource hopping pattern from the first resource hopping pattern belonging to the resource hopping pattern pool comprises:
puncturing the first resource hopping pattern to produce the second resource hopping pattern, wherein puncturing comprises:
omitting at least one resource location from the first hopping pattern.

15. The apparatus of claim 13 further configured to communicate signalling that at least partly indicates how to derive the second resource hopping pattern from the first resource hopping pattern.

16. The apparatus of claim 13 further configured to communicate signalling indicating an index of the first resource hopping pattern.

17. The apparatus of claim 13 further configured to communicate signalling to configure the resource hopping pool.

18. The apparatus of claim 13, wherein the apparatus is a network device, and wherein:
the pool comprises at least one group of resource hopping patterns, wherein within each group of resource hopping patterns the resource hopping patterns are orthogonal to each other;
the network device further configured to assign the same hopping pattern to multiple apparatus.

19. The apparatus of claim 13, wherein the apparatus is a network device, and wherein:
the pool comprises at least one group of resource hopping patterns, wherein within each group of resource hopping patterns the resource hopping patterns are orthogonal to each other, and wherein a respective different MA signature is associated with each group of resource hopping patterns;
the network device further configured to:
assign a resource hopping pattern, the resource hopping pattern being one of the resource hopping patterns of one of the at least one group, and assigning the respective MA signature of the one of the at least one group.

20. The apparatus of claim 18, wherein the apparatus is further configured to assign an MA Signature hopping sequence that hops simultaneously with resource hopping.
